(19) United States
(12) Patent Application Publication
(10) Pub. No.: US 2025/0252608 A1
(43) Pub. Date: Aug. 7, 2025

(54) POLYGON-FAN BASED CONNECTIVITY CODING FOR POLYGON MESH COMPRESSION

(71) Applicant: Tencent America LLC, Palo Alto, CA (US)

(72) Inventors: Chao HUANG, Palo Alto, CA (US); Thuong NGUYEN CANH, Palo Alto, CA (US); Xiaozhong XU, State College, PA (US); Shan LIU, San Jose, CA (US)

(73) Assignee: Tencent America LLC, Palo Alto, CA (US)

(21) Appl. No.: 19/043,034

(22) Filed: Jan. 31, 2025

Related U.S. Application Data
(60) Provisional application No. 63/549,345, filed on Feb. 2, 2024.
(60) Provisional application No. 63/570,217, filed on Mar. 26, 2024.
(60) Provisional application No. 63/682,187, filed on Aug. 12, 2024.

(51) Int. Cl. G06T 9/00

(52) U.S. Cl. CPC G06T 9/001

(57) ABSTRACT

Some aspects of the disclosure provide a method of mesh decoding processing. The method includes receiving a bitstream including coded information of a polygon mesh, the polygon mesh including vertices that are connected into polygons, the coded information indicates connectivity information of the vertices. The method also includes determining a first connectivity of a first polygon-fan with a first vertex being a pivot vertex of the first polygon-fan according to the coded information; detecting that a second vertex in the first polygon-fan is a a visited vertex that has existing neighborhood information; checking whether the existing neighborhood information of the second vertex and new neighboring information of the second vertex in the first polygon-fan satisfy a condition; and updating the existing neighborhood information of the second vertex based on the new neighboring information when the condition is satisfied.

### INCORPORATION BY REFERENCE

The present application claims the benefit of priority to U.S. Provisional Application No. 63/549,345 filed on Feb. 2, 2024, U.S. Provisional Application No. 63/570,217 filed on Mar. 26, 2024, and U.S. Provisional Application No. 63/682,187 filed on Aug. 12, 2024. The entire disclosure of the prior applications is hereby incorporated by reference in their entirety.

### TECHNICAL FIELD

The present disclosure describes aspects generally related to mesh coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Various technologies are developed to capture and represent the world, such as objects in the world, environments in the world, and the like in 3-dimensional (3D) space. 3D representations of the world can enable more immersive forms of interaction and communication. For example, technology developments in 3D media processing, such as advances in three dimensional (3D) capture, 3D modeling, and 3D rendering, and the like have promoted the ubiquitous presence of 3D media contents across several platforms and devices. In an example, a baby's first step can be captured in one continent, media technology can allow grandparents to view (and maybe interact) and enjoy an immersive experience with the baby in another continent. According to an aspect of the disclosure, in order to improve immersive experience, 3D models are becoming ever more sophisticated, and the creation and consumption of 3D models occupy a significant amount of data resources, such as data storage, data transmission resources. In some examples, 3D meshes can be used as 3D representations of the world.

### SUMMARY

Aspects of the disclosure include bitstreams, methods and apparatuses for mesh encoding/decoding. In some examples, an apparatus for mesh encoding/decoding includes processing circuitry.

Some aspects of the disclosure provide a method of mesh decoding processing. The method includes receiving a bitstream including coded information of a polygon mesh, the polygon mesh includes vertices that are connected into polygons, the coded information indicates connectivity information of the vertices. The method also includes determining a first connectivity of a first polygon-fan with a first vertex being a pivot vertex of the first polygon-fan according to the coded information; detecting that a second vertex in the first polygon-fan is a visited vertex that has existing neighborhood information; checking whether the existing neighborhood information of the second vertex and new neighboring information of the second vertex in the first polygon-fan satisfy a condition; and updating the existing neighborhood information of the second vertex based on the new neighboring information when the condition is satisfied.

Some aspects of the disclosure provide a method of mesh encoding processing. The method includes encoding a first connectivity of a first polygon-fan into coded information of a polygon mesh, the polygon mesh including vertices that are connected into polygons, the first polygon-fan including a first vertex being a pivot vertex of the first polygon-fan; detecting that a second vertex in the first polygon-fan is a visited vertex that has existing neighborhood information; checking whether the existing neighborhood information of the second vertex and new neighboring information of the second vertex in the first polygon-fan satisfy a condition; and updating the existing neighborhood information of the second vertex based on the new neighboring information when the condition is satisfied.

Some aspects of the disclosure provide a method of processing mesh data, the method includes processing a bitstream of mesh data according to a format rule. The polygon mesh includes vertices that are connected into polygons, the coded information indicates connectivity information of the vertices the polygon mesh. The format rule specifies that: a first connectivity of a first polygon-fan with a first vertex being a pivot vertex of the first polygon-fan is determined according to the coded information; a second vertex in the first polygon-fan being a visited vertex that has existing neighborhood information is detected; whether the existing neighborhood information of the second vertex and new neighboring information of the second vertex in the first polygon-fan satisfy a condition is checked; and the existing neighborhood information of the second vertex is updated based on the new neighboring information when the condition is satisfied.

Aspects of the disclosure also provide an apparatus for mesh processing. The apparatus for mesh processing including processing circuitry configured to implement any of the described methods for mesh processing.

Aspects of the disclosure also provide a non-transitory computer-readable medium storing instructions which, when executed by a computer, cause the computer to perform any of the described methods for mesh processing.

In some examples, the techniques provided in the present disclosure can reduce the number of topological configurations and/or the number of split vertices, and thus can improve coding efficiency.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a streaming system in some examples.

FIG. 2 is a schematic illustration of an example of a block diagram of a video decoder.

FIG. 3 is a schematic illustration of an example of a block diagram of a video encoder.

FIG. 4 shows an example of an encoding process for mesh processing according to an aspect of the disclosure.

FIG. 5 shows an example of a decoding process for mesh processing according to an aspect of the disclosure.

FIG. 6 shows an example of a polygon-fan according to an aspect of the disclosure.

FIG. 7 shows examples of topological configurations for triangle based connectivity coding in some examples.

FIG. 8 shows pseudo codes for neighborhood information update in some examples.

FIG. 9 shows a table of topological configurations in some examples.

FIG. 10 shows a diagram of neighborhood information update in some examples.

FIG. 11 shows pseudo codes for neighborhood information update in some examples.

FIG. 12 shows a diagram of neighborhood information update in some examples.

FIG. 13 shows a flow chart outlining a process according to some aspects of the disclosure.

FIG. 14 shows a flow chart outlining a process according to some aspects of the disclosure.

FIG. 15 shows a flow chart outlining a process according to some aspects of the disclosure.

FIG. 16 shows a flow chart outlining a process according to some aspects of the disclosure.

FIG. 17 shows a connected component in an example.

FIG. 18 shows a flow chart outlining a process according to some aspects of the disclosure.

FIG. 19 shows a flow chart outlining a process according to some aspects of the disclosure.

FIG. 20 is a schematic illustration of a computer system in accordance with an aspect.

### DETAILED DESCRIPTION

Aspects of the disclosure provide techniques in the field of mesh processing.

A mesh (also referred to as mesh model) includes several polygons (also referred to as faces) that describe the surface of a volumetric object. Each polygon can be defined by vertices in three dimensional (3D) space and the information of how the vertices are connected, referred to as connectivity information. In some examples, the mesh also includes vertex attributes, such as colors, normals, displacements, and the like, that are associated with the mesh vertices. Further, in some examples, the mesh can include attributes associated with the surface of the mesh by exploiting mapping information that parameterizes the mesh with two dimensional (2D) attribute maps. Such mapping is usually described by a set of parametric coordinates, referred to as UV coordinates or texture coordinates, associated with the mesh vertices. 2D attribute maps are used to store high resolution attribute information, such as texture, normals, displacements, and the like. The 2D attribute maps can be used for various purposes such as texture mapping, shading and mesh reconstruction and the like.

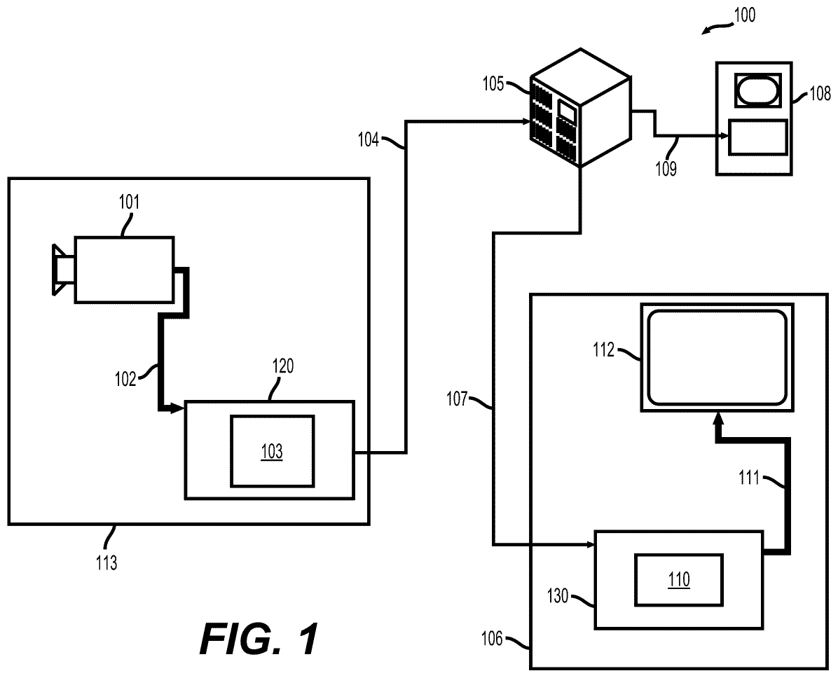

FIG. 1 shows a block diagram of a streaming system (100) in some examples. The streaming system (100) is an example of an application for the disclosed subject matter, a mesh encoder and a mesh decoder in a streaming environment. The disclosed subject matter can be equally applicable to other mesh enabled applications, including, for example, conferencing, 3D TV, streaming services, storing of compressed 3D data on digital media including CD, DVD, memory stick and the like, and so on.

The streaming system (100) includes a capture subsystem (113), that can include a 3D source (101), for example light detection and ranging (LIDAR) systems, 3D cameras, 3D scanners, a graphics generation component and the like for creating a stream of 3D data (102) that are uncompressed. In an example, the stream of 3D data (102) includes samples that are taken by the 3D camera system. The stream of 3D data (102), depicted as a bold line to emphasize a high data volume when compared to encoded 3D data (104) (or encoded bitstreams), can be processed by an electronic device (120) that includes a 3D encoder (103) coupled to the 3D source (101). The 3D encoder (103) can include hardware, software, or a combination thereof to enable or implement aspects of the disclosed subject matter as described in more detail below. The encoded 3D data (104) (or encoded bitstream), depicted as a thin line to emphasize the lower data volume when compared to the stream of 3D data (102), can be stored on a streaming server (105) for future use. One or more streaming client subsystems, such as client subsystems (106) and (108) in FIG. 1 can access the streaming server (105) to retrieve copies (107) and (109) of the encoded 3D data (104). A client subsystem (106) can include a 3D decoder (110), for example, in an electronic device (130). The 3D decoder (110) decodes the incoming copy (107) of the encoded 3D data and creates an outgoing stream of 3D representation (111) that can be rendered on a display (112) (e.g., display screen) or other rendering device (not depicted). In some streaming systems, the encoded 3D data (104), (107), and (109) (e.g., video bitstreams) can be encoded according to certain 3D coding/compression standards, such as mesh coding/compression standards and the like.

It is noted that the electronic devices (120) and (130) can include other components (not shown). For example, the electronic device (120) can include a 3D decoder (not shown) and the electronic device (130) can include a 3D encoder (not shown) as well.

It is also noted that, in some examples, the 3D encoders and/or the 3D decoders can use 2D encoding/decoder techniques. For example, the 3D encoder and/or the 3D decoders can include video encoders or video decoders.

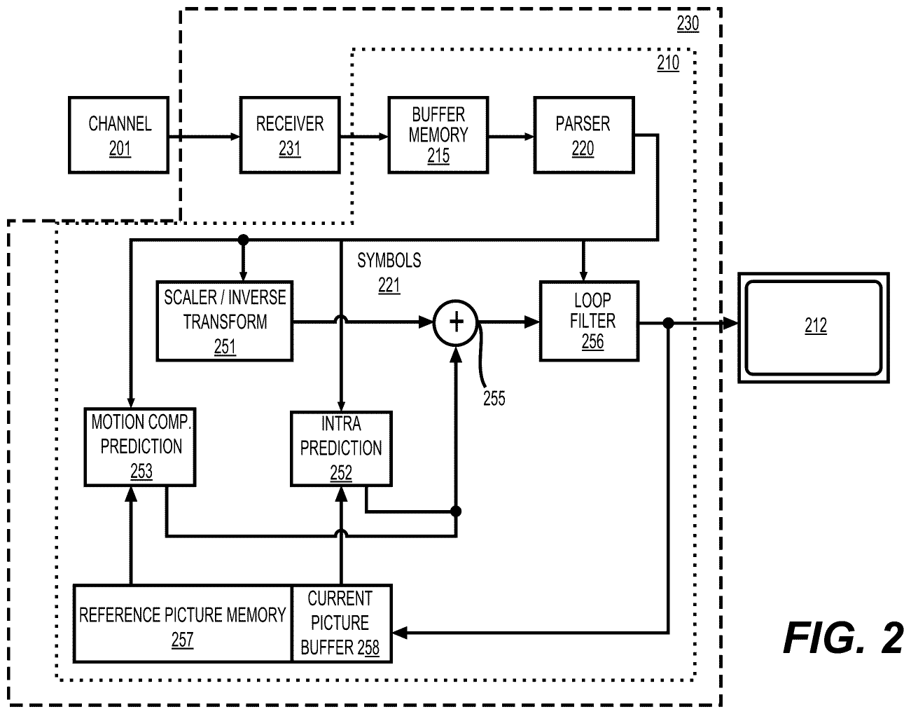

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the 3D decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

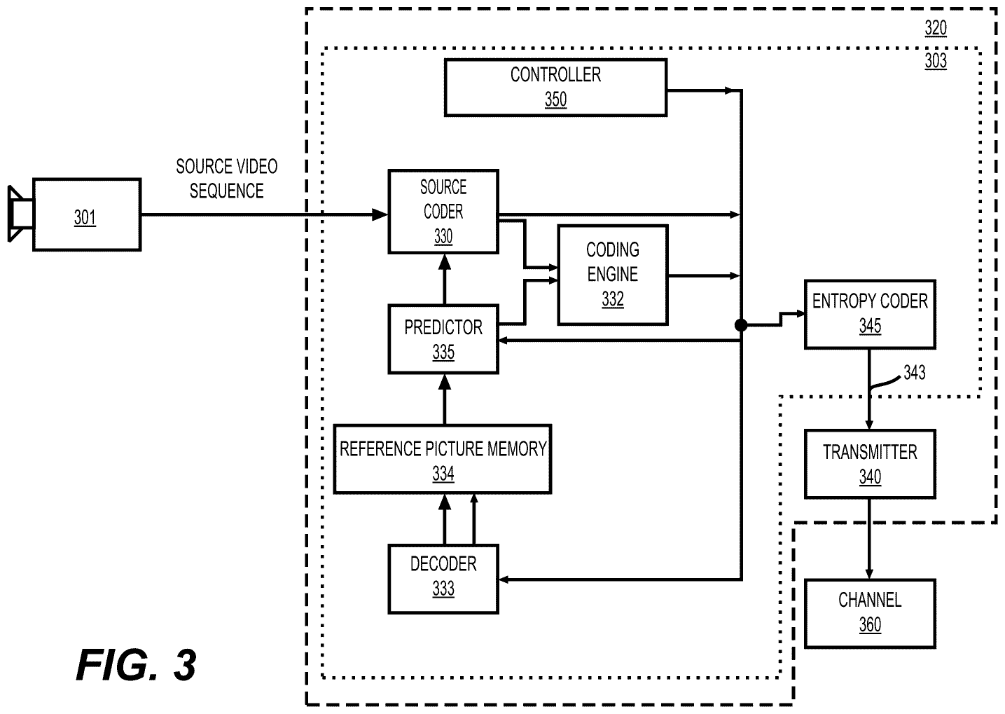

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the 3D encoder (103) in the FIG. 1 example.

The video encoder (303) may receive video samples from a video source (301) (that is not part of the electronic device (320) in the FIG. 3 example) that may obtain video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the encoders (103) and (303), and the decoders (110) and (210) can be implemented using any suitable technique. In an aspect, the encoders (103) and (303) and the decoders (110) and (210) can be implemented using one or more integrated circuits. In another aspect, the encoders (103) and (303), and the decoders (110) and (210) can be implemented using one or more processors that execute software instructions.

In some examples, the 3D data includes mesh models, and the 3D encoder (103) can include a mesh encoder, and the 3D decoder (110) can include a mesh decoder.

According to an aspect of the disclosure, a dynamic mesh is a mesh where at least one of the components (geometry information, connectivity information, mapping information, vertex attributes and attribute maps) varies with time. A dynamic mesh can be described by a sequence of meshes (also referred to as mesh frames). In some examples, mesh frames in a dynamic mesh can be representations of a surface of an object at different time, and each mesh frame is a representation of the surface of the object at a specific time (also referred to as a time instance). The dynamic mesh may require a large amount of data since the dynamic mesh may include a significant amount of information changing over time. Compression technologies of meshes can allow efficient storage and transmission of media contents in the mesh representation.

A dynamic mesh sequence may require a large amount of data since the dynamic mesh may include a significant amount of information changing over time. Therefore, efficient compression technologies may be used to store and transmit such contents.

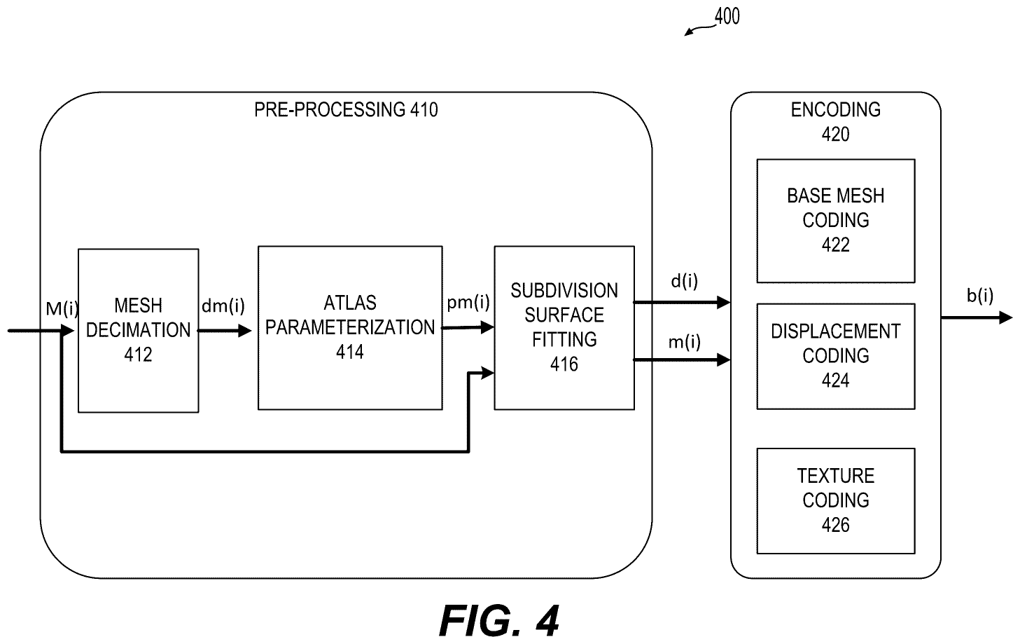

FIG. 4 shows an example of an encoding process (400) for mesh processing according to an aspect of the disclosure. As shown in FIG. 4, the encoding process (400) includes a pre-processing step (410) and an encoding step (420). The pre-processing step (410) is configured to generate a base mesh m(i) of a current frame and a displacement field d(i) of the current frame that includes displacement vectors according to an input mesh M(i) of the current frame. The encoding step (420) is configured to encode the base mesh m(i), the displacement field d(i), and texture information of the base mesh m(i). The displacement field d(i) of the current frame includes displacement vectors. An index i is used to refer to the current frame. In an aspect, a mode decision method may be performed in the encoding process (400) to determine whether inter coding (also referred to as inter frame prediction or an inter mode), intra coding (also referred to as intra frame prediction or an intra mode), or the like is applied to the current frame. For example, the mode decision method may compare a cost of an intra mode and a cost of an inter mode and decide a coding mode of the base mesh m(i) of the current frame based on which one of the costs is smaller. In some examples, a skip mode is used to code the base mesh m(i). In an example, the skip mode is a special mode of the inter mode. For example, the base mesh m(i) may be intra coded, or inter coded, or coded with the SKIP mode.

Still referring to FIG. 4, the pre-processing step (410) may include a mesh decimation process (412), a parameterization process such as an atlas parameterization process (414), and a subdivision surface fitting process (416). The mesh decimation process (412) is configured to down-sample vertices of the input mesh M(i) to generate a decimated mesh dm(i) that may include a plurality of decimated (or down-sampled) vertices. In an example, a number of the plurality of decimated vertices is less than a number of the vertices of the input mesh M(i). The parameterization process such as the atlas parameterization process (414) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UV Atlas tool. The subdivision surface fitting process (416) is configured to take the re-parameterized mesh pm(i) and the input mesh M(i) as inputs and produce a based mesh m(i) together with the displacement field d(i) that includes the displacement vectors or a set of displacements. In an example of the subdivision surface fitting process (416), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. An increase in compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms such as wavelet decomposition, which can offer high compression performance.

In the FIG. 4 example, the encoding step (420) includes a base mesh coding (422), a displacement coding (424), a texture coding (426), and the like. The base mesh coding (422) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′(j)) associated with a reference frame indicated by an index j may be used to predict the base mesh m(i) associated with the current frame indicated by the index i. The displacement coding (424) is configured to encode the displacement field d(i) that is generated in the pre-processing step (410). The displacement field d(i) may include a set of displacement vectors (or displacements) associated with the subdivided mesh vertices. The texture coding (426) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (420) starts with a pre-processing (e.g., the pre-processing step (410)). The pre-processing may convert the input mesh (e.g., the input dynamic mesh) M(i) into the base mesh m(i) together with the displacement field d(i) including a set of displacements (or a set of displacement vectors). The encoding step (420) may compress outputs (e.g., m(i), d(i), and the like) from the pre-processing and generate a compressed bitstream b(i). The compressed bitstream b(i) may include a compressed base mesh bitstream, a compressed displacement field bitstream, a compressed attribute bitstream, and/or the like.

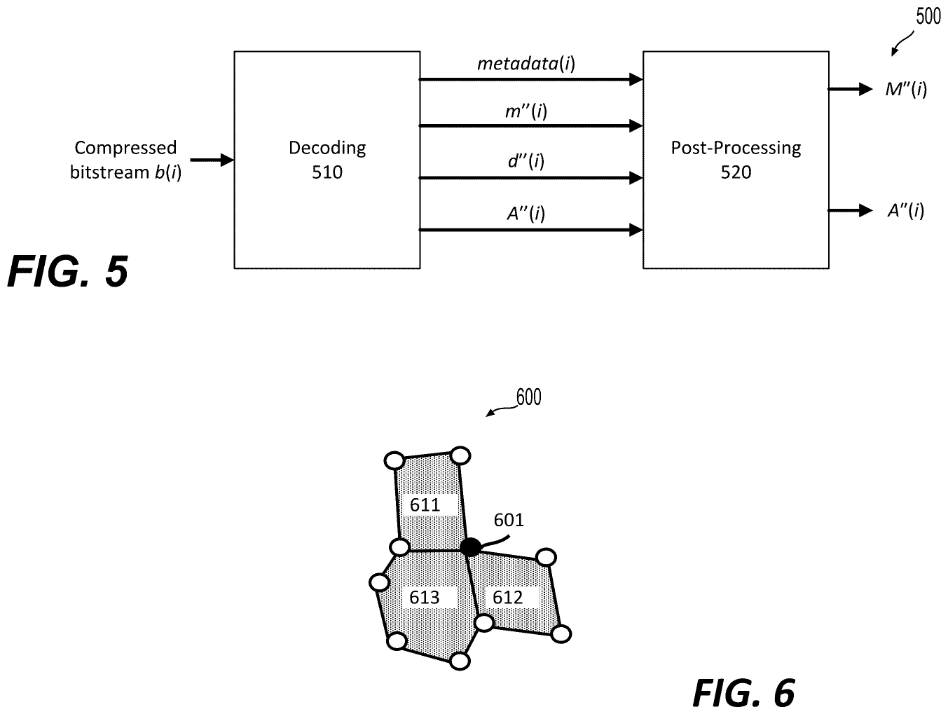

FIG. 5 shows an example of a decoding process (500) for mesh processing according to an aspect of the disclosure. The decoding process (500) may include a decoding step (510) and a post-processing step (520). A compressed bitstream b(i) may be fed to the decoding step (510). In an example, such as for a lossless transmission, the compressed bitstream b(i) is the output b(i) from the encoding process (400). The decoding step (510) may extract various sub-bitstreams such as the compressed base mesh sub-stream, the compressed displacement field sub-stream, the compressed attribute sub-stream, and/or the like. The decoding step (510) may decompress the sub-bitstreams to generate the following components: patch metadata indicated by metadata(i), a decoded base mesh m″(i), a decoded displacement field (including displacements) d″(i), a decoded attribute map A″(i), and/or the like.

In an aspect, the base mesh sub-stream may be fed to a mesh decoder to generate a reconstructed quantized base mesh m′(i). The decoded base mesh (or reconstructed base mesh) m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and unquantized transformed coefficients (e.g., wavelet coefficients). An inverse wavelet transform may be applied to the unpacked and unquantized wavelet coefficients to generate the decoded displacement field (or reconstructed displacement) d″(i).

The decoded components (e.g., including metadata(i), m″(i), d″(i), A″(i), and/or the like) may be fed to a post-processing step (520). A mesh (also referred to as a decoded/reconstructed mesh) M″(i) may be generated by the post-processing step (520) based on m″(i) and d″(i). In an example, the mesh M″(i) (also referred to as a reconstructed deformed mesh DM(i)) may be obtained by subdividing m″(i) using a subdivision scheme and applying the reconstructed displacements d″(i) to vertices of a subdivided mesh. In an example, the DM (i) may include the displaced curve. In an example, when the encoding process (400), the decoding process (500), and the transmission are lossless, the mesh M″(i) may be identical to the input mesh M(i). When one of the encoding process (400), the decoding process (500), and the transmission is lossy, M″(i) is different from M(i). In various examples, the difference, if any, between M″(i) and M(i) may be relatively small. In an example, an attribute map A “(i) is also generated by the post-processing step (520).

In some examples, the mesh can also include attributes, such as color, normal, and the like, associated with the vertices. The attributes can be associated with the surface of the mesh by exploiting mapping information that parameterizes the mesh with 2D attribute maps. The mapping information is usually described by a set of parametric coordinates, referred to as UV coordinates or texture coordinates, associated with the mesh vertices. 2D attribute maps (referred to as texture maps in some examples) are used to store high resolution attribute information such as texture, normals, displacements etc. Such information could be used for various purposes such as texture mapping and shading.

According to some aspects, a polygon mesh encoder is used for base mesh coding. The polygon mesh encoder includes a geometry encoder and an attribute encoder. The geometry encoder is configured to generate a geometry compressed bitstream and the attribute encoder is configured to generate an attribute compressed bitstream. The geometry compressed bitstream and the attribute compressed bitstream are multiplexed into a final bitstream in some examples.

In some examples, the geometry encoder can use polygon-fan connectivity coding and polygon-fan geometry coding. For example, the geometry encoder can traverse the vertices of a mesh (also referred to as polygon mesh in some examples) according to an order reproducible at the decoder side. For a vertex of the mesh, the geometry encoder can decompose the faces (e.g., also referred to as polygons, polygon faces in some examples) incident to the vertex into a set of polygon-fans sharing the vertex as a pivot. A polygon-fan includes one or more faces (e.g., polygons) that are incident to a same vertex (referred to as pivot vertex), and the one or more faces are consecutive faces, two neighboring faces in the one or more consecutive faces share an edge. The polygon-fans that are incident to the vertex (pivot vertex) are triangulated and encoded using triangle based connectivity coding and triangle based geometry coding in some examples.

In some embodiments, a polygon mesh can include geometry information and connectivity information. In some examples, the geometry information is described by a set of 3D positions associated with the vertices of the polygon mesh. In an example, (x,y,z) coordinates can be used to describe the 3D positions of the vertices, and are also referred to as 3D coordinates. In some examples, the connectivity information includes a set of vertex indices that describes how to connect the vertices to create a 3D surface.

FIG. 6 shows an example of a polygon-fan (600) according to an aspect of the disclosure. The polygon-fan (600) includes three incident faces (611)-(612) that share a pivot (or a pivot vertex) (601). In an aspect, all faces in a polygon-fan are incident to a pivot vertex, and the polygon-fan includes consecutive faces. Two of the consecutive faces may share an edge.

In an example, connectivity and geometry of polygon-fans are encoded in an interleaved manner. For each polygon-fan, connectivity information of the respective polygon-fan is encoded. The connectivity information is then used to assist the geometry information encoding.

In some examples, the connectivity and geometry of polygon-fans are coded using triangle based connectivity coding and triangle based geometry coding. For example, to encode the connectivity at a pivot vertex, for each polygon-fan, the number of faces and every face's degree (e.g., the number of incident vertices) are coded using an entropy coding method. Then the polygon-fan is triangulated, resulting a triangle-fan. The connectivity of the triangle-fan is then coded using topological configurations.

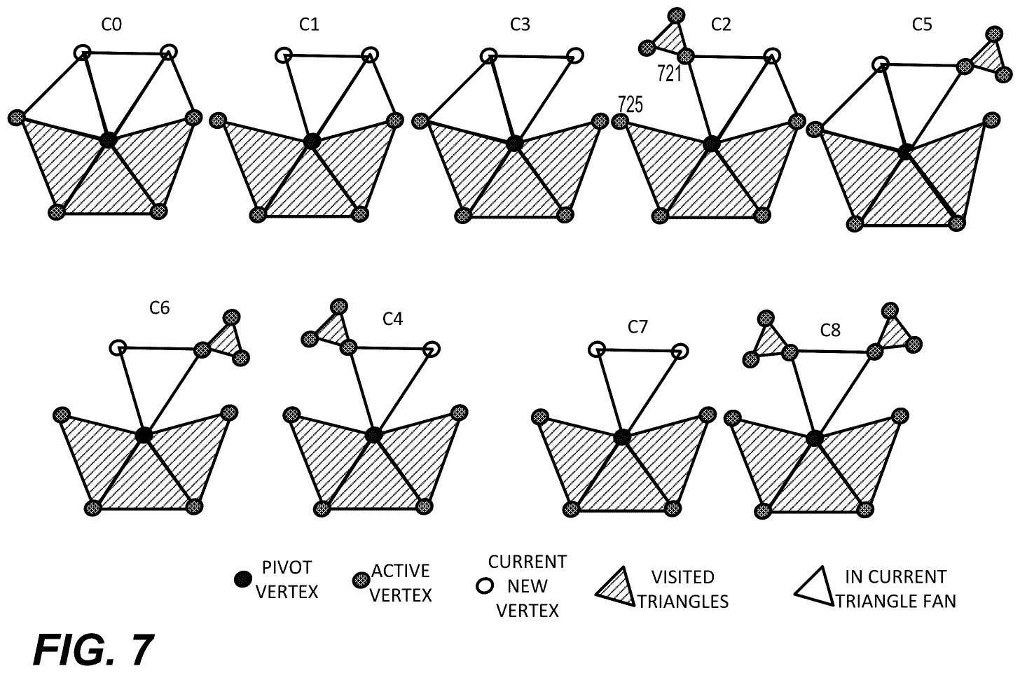

FIG. 7 shows examples of topological configurations C0-C8 for triangle based connectivity coding in some examples. In the FIG. 7 example, a current polygon-fan is triangulated, such as shown by the blank triangles. For example, the polygon-fan of C0 includes 3 blank triangles, the polygon-fan of C1 includes 2 blank triangles, and the polygon-fan of C4 includes 1 blank triangle.

In some examples, a polygon-fan is triangulated, and is categorized into one of the topological configurations, such as one of C0-C8 in FIG. 7, according to the location relationship to neighboring coded portions (e.g., shaded triangles shown in FIG. 7.) In some examples, neighborhood information can be stored and updated when new coded portion becomes available.

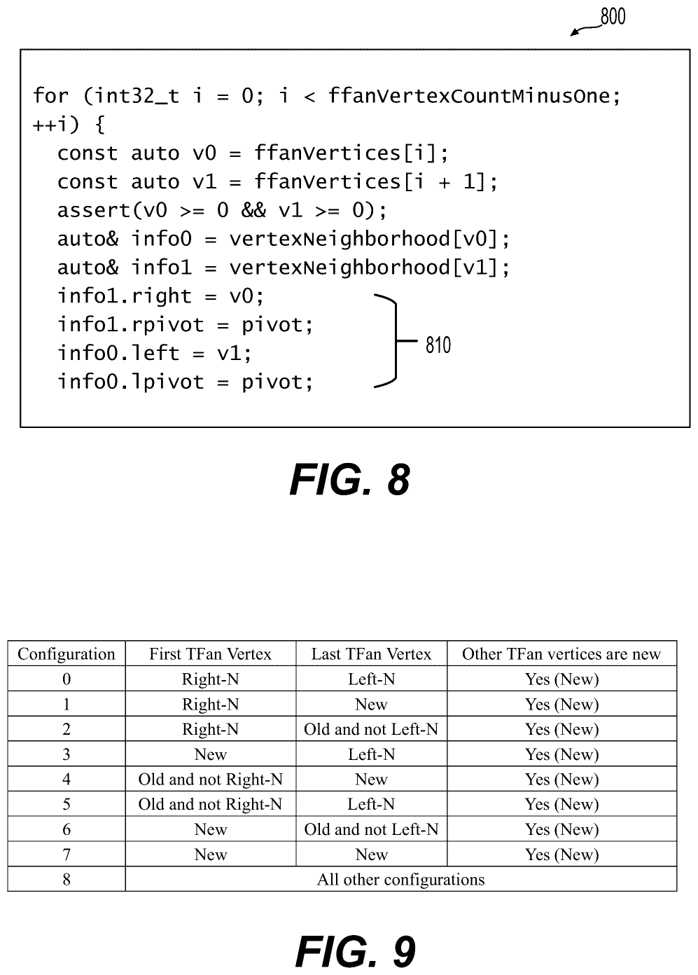

FIG. 8 shows pseudo codes (800) for neighborhood information update in some examples. For example, for each vertex (referred to as a specific vertex) in a coded polygon-fan with a pivot vertex, a vertex that is right to the specific vertex is assigned to “right” vertex of the specific vertex, a vertex that is left to the specific vertex is assigned “left” vertex of the specific vertex, and the pivot vertex is assigned the “rpivot” vertex and the “lpiovt” vertex of the specific vertex, such as shown by a portion (810) of the pseudo codes (800).

In some examples, for a pivot vertex, the coded portions for a current triangle fan (TFan) for coding can include a right vertex (referred to as Right-N) of the pivot vertex and a left vertex (Left-N) of the pivot vertex. For some of the topological configurations, the right vertex and the left vertex of the coded portions can be used to derive the vertex indices of the current triangle fan.

FIG. 9 shows a table of a derivation process for the current triangle fan (denoted by TFan) vertex indices according to the topological configurations, such as C0-C8 in FIG. 7 in some examples. The current triangle fan vertices include a first triangle fan vertex (denoted by First TFan Vertex), a last triangle fan vertex (denoted by Last TFan Vertex) and other triangle fan vertices.

In the FIG. 9 example, for some configurations, the vertex indices of the current triangle fan can be implicitly derived. For example, for the configuration 0, the first TFan vertex is derived according to right vertex of the pivot vertex in the coded neighboring portions (e.g., Right-N), and the last TFan vertex is derived according to the left vertex of the pivot vertex in the coded neighbor portions (e.g., Left-N). Further, in some examples, for new vertices (e.g., identified as new in the table of FIG. 9), the indices are derived by incrementing the vertex counter.

However, for some configurations, the vertex indices of the current triangle fan are not implied correctly. For example, in the configuration 2, the last TFan vertex (721) cannot be derived according to the left vertex (725) in the coded portions. In some examples, for each of the vertices that are identified as “Old and not Left-N” and “Old and not Right-N” in FIG. 9, the vertex index may need to be explicitly encoded in the bitstream. In some examples, the vertices that cannot be implied correctly, such as the vertices that are identified as “Old and not Left-N” and “Old and not Right-N” in FIG. 9, are referred to as split vertices. The split vertices are processed vertices, however, cannot be implied correctly.

According to an aspect of the disclosure, the polygon-fan algorithm uses nine topological configurations to code the connectivity of a polygon mesh, and also need to explicitly code the vertex indices for a large number of split vertices (e.g., identified as “Old and not Left-N” and “Old and not Right-N” in FIG. 9).

According to an aspect of the disclosure, the large number of split vertices may due to the rules of updating neighborhood information.

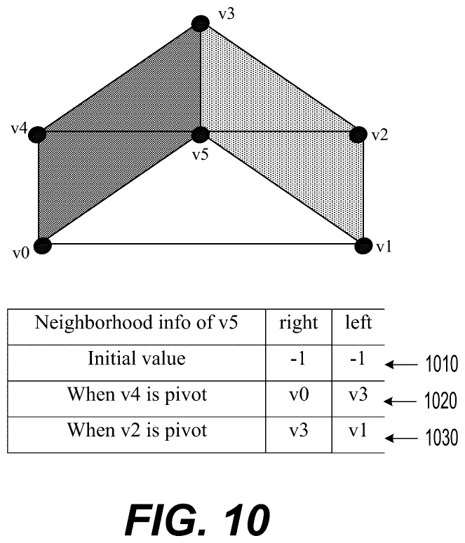

FIG. 10 shows a diagram of neighborhood information update in some examples. In an example, initially, the right vertex and the left vertex of vertices are set to an initial value. For example, the right vertex and the left vertex of vertex v5 are set of −1, as shown by (1010). During processing, when vertex v4 is the pivot vertex, the right vertex of vertex v5 (e.g., to view the vertex 5 at the pivot vertex v4) is vertex v0, and the left vertex of v5 is vertex v3, and the neighborhood information is updated accordingly as shown by (1020). During further processing, when v2 becomes the pivot vertex, the right vertex of vertex v5 becomes v3, and the left vertex of vertex v5 becomes v1, and the neighborhood information is updated accordingly as shown by (1030) in FIG. 10. Further, when vertex v5 becomes the pivot vertex, the neighborhood information of vertex 5 is not able to correctly derive the right vertex. For example, the right vertex in the neighborhood information of vertex v5 is vertex v3, but the correct right vertex is vertex 0.

Some aspects of the present disclosure provide techniques to improve the polygon-fan connectivity coding algorithm for polygon mesh compression. In some examples, the techniques can reduce the number of configurations and/or the number of split vertices. The techniques can be applied individually or can be applied by any form of combinations. According to some aspects of the disclosure, conditional neighborhood updates are performed. Various conditions can be used to determine whether to update right vertex and/or left vertex in the neighborhood information of a vertex.

In some examples, encoder/decoder can determine a first connectivity of a first polygon-fan with a first vertex being a pivot vertex of the first polygon-fan, and detect that a second vertex in the first polygon-fan is a visited vertex that has existing neighborhood information. The encoder/decoder can check whether the existing neighborhood information of the second vertex and new neighboring information of the second vertex in the first polygon-fan satisfy a condition; and update the existing neighborhood information of the second vertex based on the new neighboring information when the condition is satisfied.

In some examples, for the polygon-fan connectivity coding algorithm, such as using the pseudo codes (910) in FIG. 9, each visited vertex has neighborhood information, the neighborhood information includes the left and the right vertices relative to the visited vertex. The neighborhood information also includes the pivot vertex, which is the most recent one when the neighborhood information is created or updated. The neighborhood information can be used to determine the topological configurations of a polygon-fan.

According to an aspect of the disclosure, various conditions can be applied to determine whether to update the left vertex and/or the right vertex of a visited vertex.

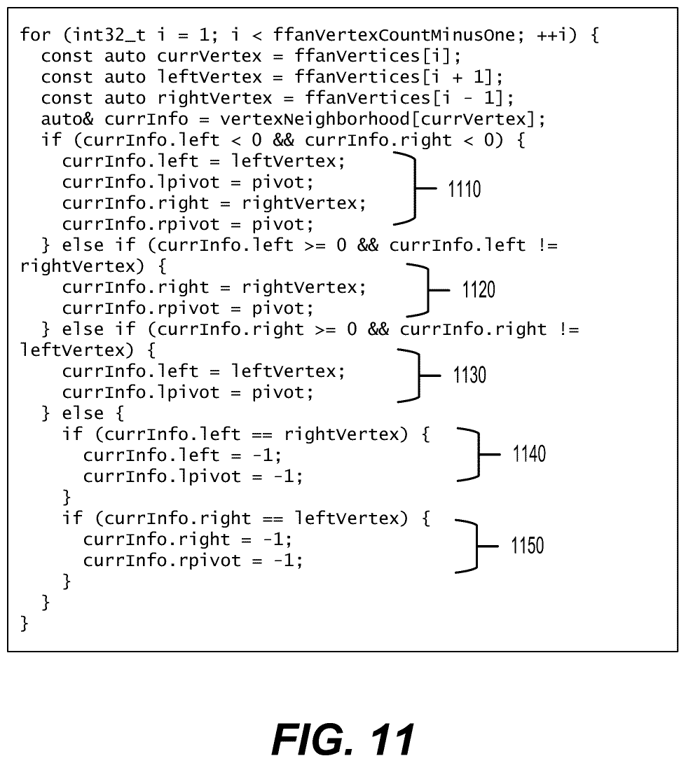

FIG. 11 shows pseudo codes (1100) for neighborhood information update in some examples.

In a first step of the FIG. 11 example, when a vertex is visited first time in a polygon-fan of a pivot vertex, the left vertex and the right vertex in the neighborhood information of the vertex are set as the left vertex and the right vertex in the polygon-fan (when available), and the pivot vertex is also be included in its neighborhood information as the left-pivot and the right-pivot, such as shown by (1110) in FIG. 11.

Further, in a second step of the FIG. 11 example, when the neighborhood information of a vertex (referred to as a specific vertex) already exists, to update the neighborhood information of the specific vertex according to a current polygon-fan, whether the left vertex of the specific vertex has been set can be checked. When the left vertex of the specific vertex has been set, and the left vertex in the neighborhood information of the specific vertex is not equal to the right vertex in the current polygon-fan, then the right vertex of the specific vertex in the current polygon-fan and the pivot vertex in the current polygon-fan are used to update neighborhood information of the specific vertex. For example, the right vertex in the neighborhood information of the specific vertex is updated to be the right vertex of the current polygon-fan, the right pivot vertex in the neighborhood information of the specific vertex is updated to be the pivot vertex of the current polygon-fan, such as shown by (1120) in FIG. 11.

Further, in a third step of the FIG. 11 example, when the right vertex and the right-pivot in the neighborhood information of the specific vertex are not updated in the second step, whether the right vertex of the specific vertex has been set can be checked. When the right vertex of the specific vertex has been set, and the right vertex in the neighborhood information of the specific vertex is not equal to the left vertex in the current polygon-fan, then the left vertex and the left-pivot (e.g., denoted by lpivot) in the neighborhood information of the specific vertex can be updated according to the left vertex in current polygon-fan and the current pivot vertex. For example, the left vertex in the neighborhood information of the specific vertex is updated to be the left vertex of the current polygon-fan, the left pivot vertex in the neighborhood information of the specific vertex is updated to be the pivot vertex of the current polygon-fan, such as shown by (1130) in FIG. 11.

Further, in a fourth step of the FIG. 11 example, when the neighborhood information is not updated in either the second step or the third step, then whether the left vertex in the neighborhood information is equal to the right vertex in the current polygon-fan is checked. When the left vertex in the neighborhood information is equal to the right vertex in the current polygon-fan, the left vertex and left-pivot in the neighborhood information of the specific vertex are reset to the unvisited state, such as shown by (1140) in FIG. 11. Similarly, whether the right vertex in the neighborhood information is equal to the left vertex in the current polygon-fan is checked. When the right vertex in the neighborhood information is equal to the left vertex in the current polygon-fan, the right vertex and right-pivot (e.g., denoted by rpivot) in the neighborhood information of the specific vertex is reset to the unvisited state, such as shown by (1150) in FIG. 11.

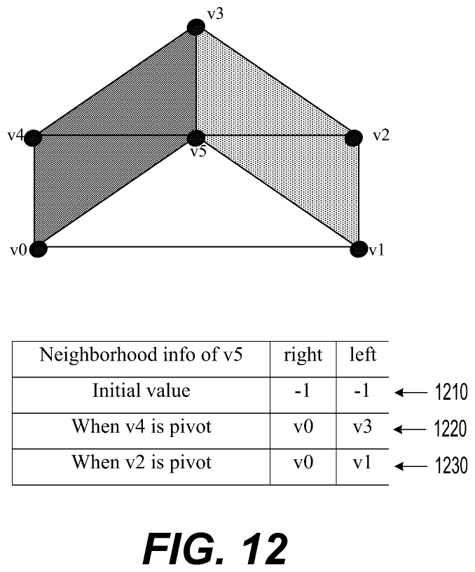

FIG. 12 shows a diagram of neighborhood information update in some examples, such as using the pseudo codes (1100) in FIG. 11. The polygon mesh in FIG. 12 is the same as the polygon mesh in FIG. 10, however the neighborhood information update is performed differently.

In an example, initially, the right vertex and the left vertex of vertices are set to an initial value. For example, the right vertex and the left vertex of vertex v5 are set of −1, as shown by (1210).

During processing, when vertex v4 is the pivot vertex, according to the first step in the FIG. 11 example, the right vertex of vertex v5 is vertex v0, and the left vertex of v5 is vertex v3, as shown by (1220).

During further processing, when v2 becomes the pivot vertex, the neighborhood information of vertex 5 already exists. The left vertex of vertex 5 in the neighborhood information is vertex v3, and is equal to the right vertex of the current polygon-fan (with pivot vertex v2), no update to the right vertex and right-pivot in the neighborhood information of the vertex v5 is performed according to the second step of the pseudo codes in the FIG. 11 example.

Further, according to the third step of the FIG. 11 example, the right vertex of vertex 5 in the neighborhood information is vertex v0, and is not equal to the left vertex (e.g., vertex v1) of the current polygon-fan, then the left vertex in the neighborhood information of vertex 5 is updated to be vertex v1, and the left-pivot in the neighborhood information of the vertex 5 is updated to be vertex v2, such as shown by (1230).

Further, when vertex v5 becomes the pivot vertex, the neighborhood information of vertex 5 can be used to derive the right vertex and the left vertex of the current polygon-fan.

According to another aspect of the disclosure, in some examples, the topological configuration of the polygon-fan of the initial vertex of a connected component is usually the configuration 4 (C3) or the configuration 8 (C7). In some examples, a separate arithmetic context can be used to encode/decode the polygon-fan configurations of initial vertices. In a mesh, a connected component refers to a group of vertices (or faces) that are connected through a series of edges. From any vertex in the connected component, a navigation path (e.g., one or more edges in the connected component) exists in the connected component to any other vertex in the connected component. In some examples, a node with no edges is itself a connected component.

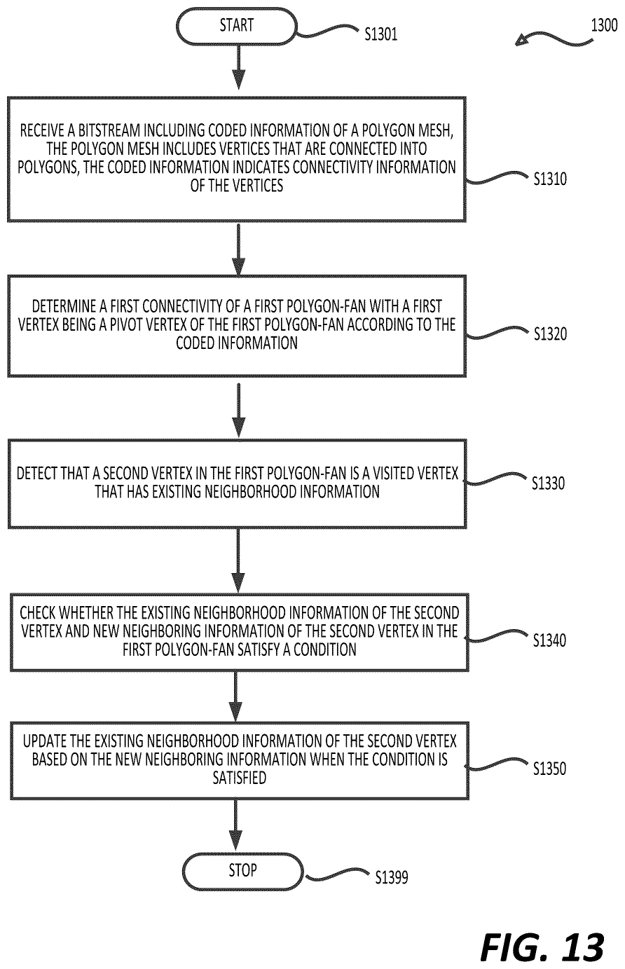

FIG. 13 shows a flow chart outlining a process (1300) according to an aspect of the disclosure. The process (1300) can be used in a mesh decoder. In various aspects, the process (1300) is executed by processing circuitry, such as the processing circuitry that performs functions of the 3D decoder (110), and the like. In some aspects, the process (1300) is implemented in software instructions, thus when the processing circuitry executes the software instructions, the processing circuitry performs the process (1300). The process starts at (S1301) and proceeds to (S1310).

At (S1310), a bitstream including coded information of a polygon mesh is received. The polygon mesh includes vertices that are connected into polygons, the coded information indicates connectivity information of the vertices.

At (S1320), a first connectivity of a first polygon-fan with a first vertex being a pivot vertex of the first polygon-fan is determined according to the coded information.

At (S1330), a second vertex in the first polygon-fan being a visited vertex that has existing neighborhood information is detected.

At (S1340), whether the existing neighborhood information of the second vertex and new neighboring information of the second vertex in the first polygon-fan satisfy a condition is checked.

At (S1350), the existing neighborhood information of the second vertex is updated based on the new neighboring information when the condition is satisfied.

According to an aspect of the disclosure, whether a left vertex is set in the existing neighborhood information of the second vertex is checked. When the left vertex is set in the existing neighborhood information of the second vertex, whether the left vertex in the existing neighborhood information is equal to a right vertex of the second vertex in the first polygon-fan is checked. In some examples, when the left vertex in the existing neighborhood information is not equal to the right vertex of the second vertex in the first polygon-fan, a right vertex in the existing neighborhood information is updated according to the right vertex of the second vertex in the first polygon-fan. Further, in an example, a right pivot in the existing neighborhood information according to the pivot vertex of the first polygon-fan.

According to another aspect of the disclosure, whether a right vertex is set in the existing neighborhood information of the second vertex is checked. When the right vertex is set in the existing neighborhood information of the second vertex, whether the right vertex in the existing neighborhood information is equal to a left vertex of the second vertex in the first polygon-fan is checked. In some examples, when the right vertex in the existing neighborhood information is not equal to the left vertex of the second vertex in the first polygon-fan, a left vertex in the existing neighborhood information is updated according to the left vertex of the second vertex in the first polygon-fan. Further, in an example, a left pivot in the existing neighborhood information is updated according to the pivot vertex of the first polygon-fan.

In some examples, a left vertex and/or a right vertex in the existing neighborhood information of the second vertex can be reset to an unvisited state when the existing neighborhood information and the new neighboring information satisfy one or more conditions. In an example, the left vertex in the existing neighborhood information of the second vertex is reset to the unvisited state when the left vertex in the existing neighborhood information matches a right vertex of the second vertex in the first polygon-fan. In another example, the right vertex in the existing neighborhood information of the second vertex is reset to the unvisited state when the right vertex in the existing neighborhood information matches a left vertex of the second vertex in the first polygon-fan.

In some examples, when the second vertex becomes a pivot vertex, a connectivity of a second polygon-fan that is incident to the second vertex is derived based on the existing neighborhood information (e.g., the updated existing neighborhood information) of the second vertex.

Then, the process proceeds to (S1399) and terminates.

The process (1300) can be suitably adapted. Step(s) in the process (1300) can be modified and/or omitted. Additional step(s) can be added. Any suitable order of implementation can be used.

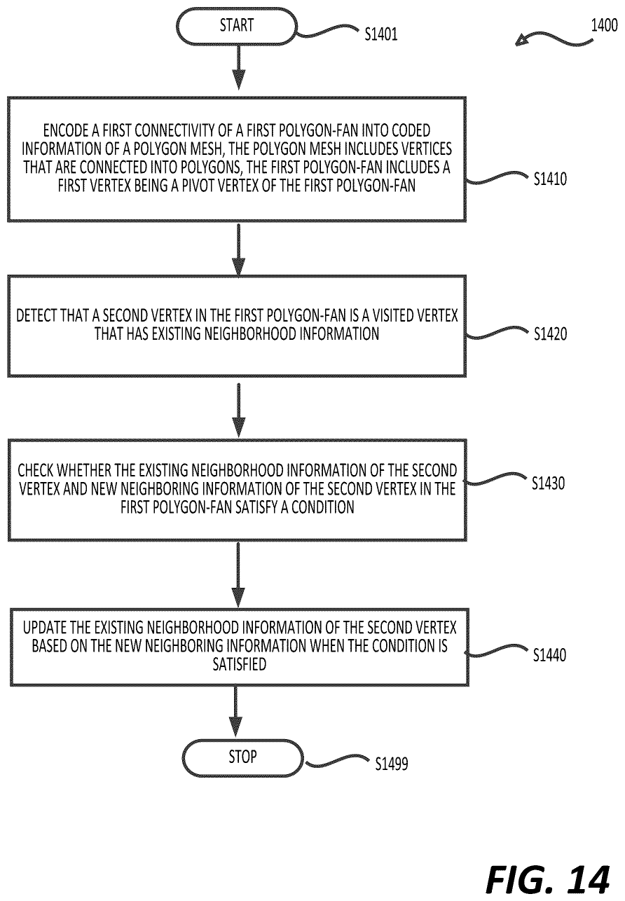

FIG. 14 shows a flow chart outlining a process (1400) according to an aspect of the disclosure. The process (1400) can be used in a mesh encoder. In various aspects, the process (1400) is executed by processing circuitry, such as the processing circuitry that performs functions of the 3D encoder (103), and the like. In some aspects, the process (1400) is implemented in software instructions, thus when the processing circuitry executes the software instructions, the processing circuitry performs the process (1400). The process starts at (S1401) and proceeds to (S1410).

At (S1410), a first connectivity of a first polygon-fan is encoded into coded information of a polygon mesh, the polygon mesh includes vertices that are connected into polygons, the first polygon-fan includes a first vertex being a pivot vertex of the first polygon-fan.

At (S1420), a second vertex in the first polygon-fan being a visited vertex that has existing neighborhood information is detected.

At (S1430), whether the existing neighborhood information of the second vertex and new neighboring information of the second vertex in the first polygon-fan satisfy a condition is checked.

At (S1440), the existing neighborhood information of the second vertex is updated based on the new neighboring information when the condition is satisfied.

According to an aspect of the disclosure, whether a left vertex is set in the existing neighborhood information of the second vertex is checked. When the left vertex is set in the existing neighborhood information of the second vertex, whether the left vertex in the existing neighborhood information is equal to a right vertex of the second vertex in the first polygon-fan is checked. When the left vertex in the existing neighborhood information is not equal to the right vertex of the second vertex in the first polygon-fan, a right vertex in the existing neighborhood information is updated according to the right vertex of the second vertex in the first polygon-fan. Further, in an example, a right pivot in the existing neighborhood information is updated according to the pivot vertex of the first polygon-fan.

According to another aspect of the disclosure, whether a right vertex is set in the existing neighborhood information of the second vertex is checked. When the right vertex is set in the existing neighborhood information of the second vertex, whether the right vertex in the existing neighborhood information is equal to a left vertex of the second vertex in the first polygon-fan is checked. In some examples, when the right vertex in the existing neighborhood information is not equal to the left vertex of the second vertex in the first polygon-fan, a left vertex in the existing neighborhood information is updated according to the left vertex of the second vertex in the first polygon-fan. Further, in an example, a left pivot in the existing neighborhood information is updated according to the pivot vertex of the first polygon-fan.

In some examples, a left vertex and/or a right vertex in the existing neighborhood information of the second vertex can be reset to an unvisited state when the existing neighborhood information and the new neighboring information satisfy one or more conditions.

In some examples, when the second vertex becomes a pivot vertex, a connectivity of a second polygon-fan that is incident to the second vertex is encoded based on the existing neighborhood information (e.g., the updated existing neighboring information) of the second vertex.

Then, the process proceeds to (S1499) and terminates.

The process (1400) can be suitably adapted. Step(s) in the process (1400) can be modified and/or omitted. Additional step(s) can be added. Any suitable order of implementation can be used.

According to an aspect of the disclosure, a method of processing mesh is provided. In the method, a conversion between a mesh file and a bitstream of compressed mesh is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a polygon mesh includes vertices that are connected into polygons, the coded information of the polygon mesh indicates connectivity information of the vertices into the polygon mesh. The format rule specifies that: a first connectivity of a first polygon-fan with a first vertex being a pivot vertex of the first polygon-fan is determined according to the coded information; a second vertex in the first polygon-fan being a visited vertex that has existing neighborhood information is detected; whether the existing neighborhood information of the second vertex and new neighboring information of the second vertex in the first polygon-fan satisfy a condition is checked; and the existing neighborhood information of the second vertex is updated based on the new neighboring information when the condition is satisfied.

According to an aspect of the disclosure, a polygon-fan algorithm, such as the techniques described with reference to FIG. 6 and FIG. 7, can be used to code the connectivity of a polygon mesh. The polygon-fan algorithm may need to encode nine topological configurations (e.g., C0-C8 in FIG. 7) and a large number of split vertices. Coding nine topological configurations and split vertices can hinder its coding efficiency. The present disclosure provides techniques to improve the polygon-fan connectivity coding algorithm for polygon mesh compression, for example by reducing the number of configurations and the number of split vertices.

In some aspects, a polygon-fan algorithm can perform vertex traversal by using an active vertex list that tracks of active vertices, the active vertices correspond to vertices to that are visited but not fully processed.

In the present disclosure, a polygon mesh refers to 2-manifold (also known as surface) with arbitrary topology, any face degrees, and any number of connected components or boundaries. According to an aspect of the disclosure, a 2-manifold can be converted to a closed-manifold by adding dummy faces. Coding a closed-manifold can be performed with reduced topological configurations and reduced number of split vertices. The added dummy faces can be informed from the decoder, can be removed from the decoded closed manifold to generate a restored 2-manifold.

In some examples, a polygon mesh can be encoded using an eleven-step algorithm, such as described in the following step E1 to step E11.

In step E1, whether a polygon mesh (e.g., an input polygon mesh for encoding) has boundaries is detected. When the polygon mesh has boundary, dummy faces are added to fill holes in the polygon mesh, such that the polygon mesh becomes a closed 2-manifold mesh. The added dummy faces are signaled (encoded in a bitstream) from the encoder to the decoder, and the decoder can remove the added dummy faces after decoding. The process can proceed to step E2.

In step E2, for each connected component in the closed 2-manifold mesh, an initial face is selected, then the face degree of the initial face is encoded. The process can proceed to step E3.

In step E3, for each incident vertex of the initial face, the positions of the incident vertex can be encoded, for example using predictive coding. The process can proceed to step E4.

In step E4, all vertices in the initial face are added to an active vertex list. The process can proceed to step E5. Both traversals keep track of a single list of “active” vertices, which correspond to vertices to be visited and compressed next.

In step E5, a vertex is selected from the active vertex list as a pivot vertex and the selected vertex is removed from the active vertex list. The process can proceed to step E6.

In step E6, polygon-fans around the pivot vertex are computed (determined) and the number of polygon-fans is encoded. When there is no more polygon-fan to encode at this pivot vertex, then the process returns to step E5 to select another vertex from the active vertex list for processing. When the number of polygon-fans is not zero, the process proceeds to step E7.

In step E7, for each polygon-fan, the number of faces in the polygon-fan and each face's degree are encoded. The process can proceed to step E8. In some examples, step E8 is skipped, and the process proceeds to step E9.

In step E8, each polygon-fan is triangulated into a triangle-fan. The process proceeds to step E9.

In step E9, split vertices in the polygon-fan or triangle-fan are signaled (encoded). The process proceeds to step E10.

In step E10, positions of new vertices in the polygon-fan/triangle-fan are encoded. After encoding the positions of the new vertices in the polygon-fan/triangle-fan, the new vertices are added into the active vertex list. When all the polygon-fans at the pivot vertex are processed, the process returns to step E7.

In step E11, whether the active vertex list is empty is checked. When the active vertex list is empty, the current connected component has been encoded, then whether there are remaining connected components to be coded can be checked. When there exists a connected component to be coded, the process proceeds to step E2; otherwise, when all connected components are encoded, the geometry of the polygon mesh (e.g., the input polygon mesh) has been encoded. When the active vertex list is not empty, the process returns to step E5.

According to an aspect of the disclosure, when a polygon mesh is a closed 2-manifold, each polygon-fan/triangle-fan can only have one configuration, which the configuration C0 in FIG. 7, thus no need to signal the configurations in an aspect. Also, in the configuration C0, the first and last vertices of the polygon-fan/triangle-fan are also known by both encoder and decoder, in some examples, the first and the last vertices are not signaled as split vertices. Then, the bits for signaling the configurations can be saved and the number of split vertices is reduced.

In some examples, a polygon mesh can be decoded and restored using an eleven-step algorithm, such as described in the following step D1 to step D11.

In step D1, whether a polygon mesh has added dummy faces is determined. When the polygon mesh has added dummy faces, the added dummy faces are signaled in a bitstream, and the decoder can decode the added dummy face information from the bitstream. The process can proceed to step D2.

In step D2, for each connected component in the polygon mesh (a closed 2-manifold mesh), an initial face is determined, then the face degree of the initial face is decoded from the bitstream. The process can proceed to step D3.

In step D3, for each incident vertex of the initial face, the positions of the incident vertex can be decoded, for example using predictive coding. The process can proceed to step D4.

In step D4, all vertices in the initial face are added to an active vertex list. The process can proceed to step D5.

In step D5, a vertex is selected from the active vertex list as a pivot vertex and the selected vertex is removed from the active vertex list. The process can proceed to step D6.

In step D6, the number of polygon-fans is decoded from the bitstream. When there is no polygon-fan to decode at this pivot vertex, then the process returns to step D5 to select another vertex from the active vertex list for processing. When the number of polygon-fans is not zero, the process proceeds to step D7.

In step D7, for each polygon-fan, the number of faces in the polygon-fan and each face's degree are decoded. The process can proceed to step D8. In some examples, step D8 is skipped, and the process proceeds to step D9.

In step D8, each polygon-fan is triangulated into a triangle-fan. The process proceeds to step D9.

In step D9, split vertices in the polygon-fan or triangle-fan are decoded. The process proceeds to step D10.

In step D10, positions of new vertices in the polygon-fan/triangle-fan are decoded. After decoding the positions of the new vertices in the polygon-fan/triangle-fan, the new vertices are added into the active vertex list. When all the polygon-fans at the pivot vertex are processed, the process returns to step D7.

In step D11, whether the active vertex list is empty is checked. When the active vertex list is empty, the current connected component has been decoded, then whether there are remaining connected components to be decoded can be checked. When there exists a connected component to be decoded, the process proceeds to step D2; otherwise, when all connected components are decoded, the geometry of the polygon mesh (e.g., the closed 2-manifold mesh) has been decoded. When the active vertex list is not empty, the process returns to step D5.

It is noted that after the geometry of the polygon mesh has been decoded, the added dummy faces can be removed to generate a restored polygon mesh.

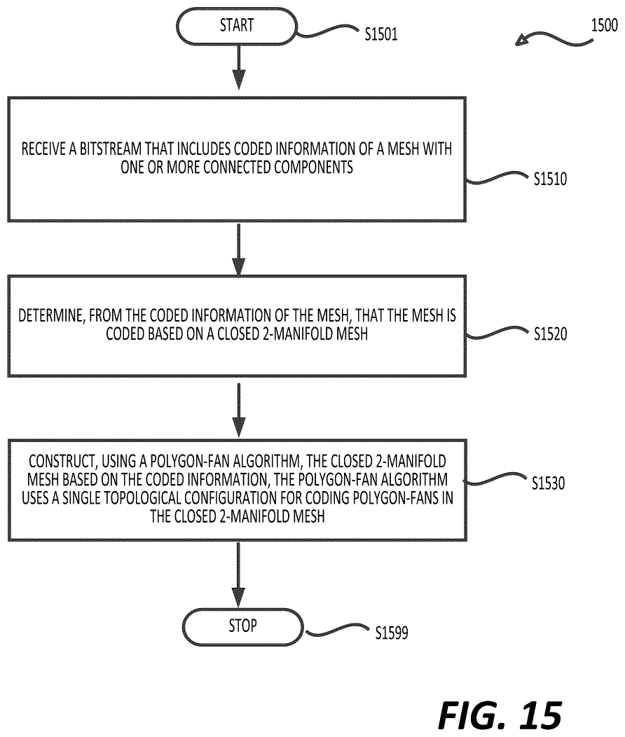

FIG. 15 shows a flow chart outlining a process (1500) according to an aspect of the disclosure. The process (1500) can be used in a mesh decoder. In various aspects, the process (1500) is executed by processing circuitry, such as the processing circuitry that performs functions of the 3D decoder (110), and the like. In some aspects, the process (1500) is implemented in software instructions, thus when the processing circuitry executes the software instructions, the processing circuitry performs the process (1500). The process starts at (S1501) and proceeds to (S1510).

At (S1510), a bitstream is received, the bitstream includes coded information of a mesh with one or more connected components.

At (S1520), from the coded information of the mesh, the mesh being coded based on a closed 2-manifold mesh is determined.

At (S1530), using a polygon-fan algorithm, the closed 2-manifold mesh is constructed based on the coded information, the polygon-fan algorithm uses a single topological configuration (e.g., C0 in FIG. 7) for coding polygon-fans in the closed 2-manifold mesh.

In some examples, from the coded information of the mesh, dummy face information that indicates one or more dummy faces that are added into the mesh is decoded, and a restored mesh is generated from the closed 2-manifold mesh with the one or more dummy faces being removed from the closed 2-manifold mesh.

In some examples, the single topological configuration has no split vertices.

In some examples, from the coded information, a face degree of an initial face of a first connected component in the one or more connected components is decoded. Also, positions of vertices of the initial face are decoded from the coded information. The vertices of the initial face are added into an active vertex list. In some examples, a vertex is selected from the active vertex list as a pivot vertex. From the coded information, a number of one or more polygon-fans about the pivot vertex is decoded. The one or more polygon-fans have the single topological configuration. Positions of new vertices of the one or more polygon-fans are decoded from the coded information. The new vertices are added in the active vertex list.

In some examples, split vertex information of the one or more polygon-fans is decoded from the coded information.

In some examples, the one or more polygon-fans are triangle-fans.

Then, the process proceeds to (S1599) and terminates.

The process (1500) can be suitably adapted. Step(s) in the process (1500) can be modified and/or omitted. Additional step(s) can be added. Any suitable order of implementation can be used.

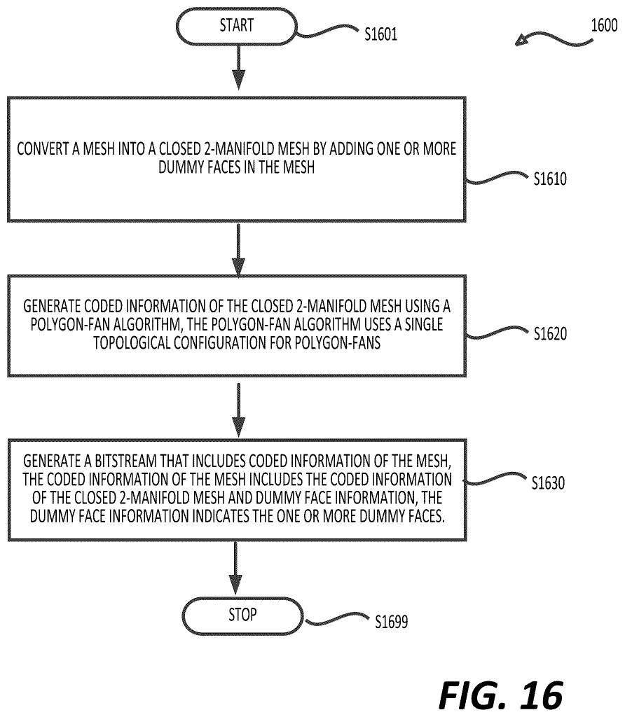

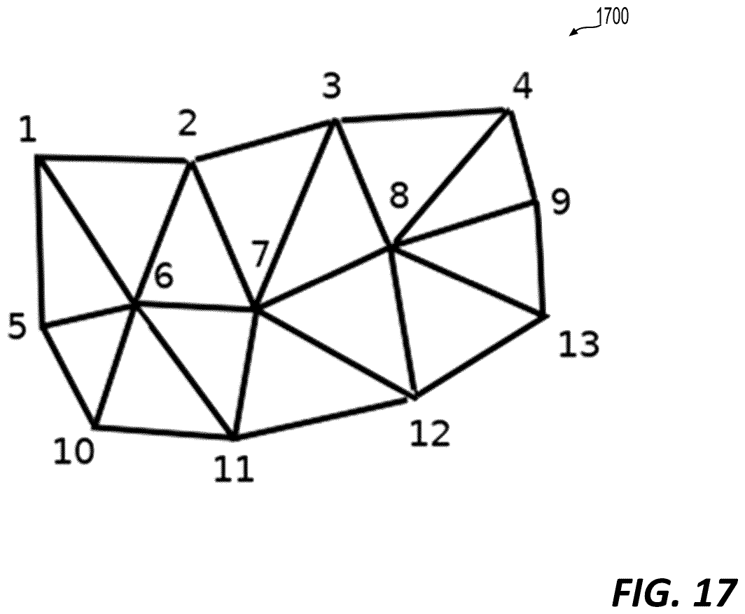

FIG. 16 shows a flow chart outlining a process (1600) according to an aspect of the disclosure. The process (1600) can be used in a mesh encoder. In various aspects, the process (1600) is executed by processing circuitry, such as the processing circuitry that performs functions of the 3D encoder (103), and the like. In some aspects, the process (1600) is implemented in software instructions, thus when the processing circuitry executes the software instructions, the processing circuitry performs the process (1600). The process starts at (S1601) and proceeds to (S1610).

At (S1610), a mesh is converted into a closed 2-manifold mesh by adding one or more dummy faces in the mesh.

At (S1620), coded information of the closed 2-manifold mesh is generated using a polygon-fan algorithm, the polygon-fan algorithm uses a single topological configuration (e.g., C0 in FIG. 7).

At (S1630), a bitstream that includes coded information of the mesh is generated, the coded information of the mesh includes the coded information of the closed 2-manifold mesh and dummy face information, the dummy face information indicates the one or more dummy faces.

In some examples, the single topological configuration has no split vertices.

In some examples, to generate the coded information of the closed 2-manifold mesh, a face degree of an initial face of a first connected component in the closed 2-manifold mesh is encoded into the coded information. Positions of vertices of the initial face are encoded into the coded information. The vertices of the initial face are added into an active vertex list. A vertex in the active vertex list is selected as a pivot vertex. A number of one or more polygon-fans about the pivot vertex is encoded into the coded information. The one or more polygon-fans have the single topological configuration. Positions of new vertices of the one or more polygon-fans are encoded into the coded information. The new vertices are added in the active vertex list.

In some examples, split vertex information of the one or more polygon-fans is encoded into the coded information.

In some examples, the one or more polygon-fans are triangle-fans.

Then, the process proceeds to (S1699) and terminates.

The process (1600) can be suitably adapted. Step(s) in the process (1600) can be modified and/or omitted. Additional step(s) can be added. Any suitable order of implementation can be used.

According to an aspect of the disclosure, a method of processing mesh is provided. In the method, a conversion between a mesh file and a bitstream of compressed mesh is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a polygon mesh includes vertices that are connected into polygons, the coded information of the polygon mesh indicates coded information of a mesh with one or more connected components. The format rule specifies that: the polygon mesh is coded based on a closed 2-manifold mesh with one or more dummy faces added. By using a polygon-fan algorithm, the closed 2-manifold mesh is reconstructed based on the coded information. The polygon-fan algorithm uses a single topological configuration for coding polygon-fans in the closed 2-manifold mesh.

According to an aspect of the disclosure, the polygon-fan algorithm can be used to code the connectivity of a polygon mesh, and the polygon-fan algorithm needs to signal the existence of each unvisited polygon-fan (e.g., not processed polygon-fan) around a pivot vertex in some examples. Some aspects of the disclosure provide techniques to improve the coding efficiency of signaling those unvisited polygon-fans, for example by using context coding in the polygon mesh compression.

In the polygon-fan coding algorithm, to signal the existence of each unvisited polygon-fan around each pivot vertex, and context coding can be used to improve the efficiency of coding polygon-fans.

In some aspects, improved context coding can be used when the pivot vertex is the initial vertex of a connected component.

When the pivot vertex is the initial vertex (i.e. the first visited vertex) of a connected component, it's almost certain that there is at least one unvisited polygon-fan, unless the pivot vertex is an isolated vertex that is not incident to any face. It is noted that this is not the case when the pivot is not an initial vertex, where there may not be any unvisited polygon-fans. Therefore, in some examples, a separate context is used to code the existence of the first unvisited polygon-fan around the pivot vertex that is the initial vertex of a connected component.

As described above, when the pivot vertex is the initial vertex of a connected component, the first unvisited polygon-fan around the pivot almost certainly exists. Not only that, it's also most likely that there is only one unvisited polygon-fan in this case, unless the pivot is non-manifold. When the pivot is not an initial vertex, multiple unvisited polygon-fans may exist around the pivot. Thus, in some examples, a separate context is used to code the existence of the second/third/ . . . unvisited polygon-fan around the pivot vertex that is the initial vertex of a connected component.

When the pivot vertex is the initial vertex of a connected component, the topological configurations of the polygon-fans around the pivot are most likely being configuration C3 or configuration C7 shown in FIG. 7.

FIG. 17 shows a connected component (1700) in an example. When vertex 7 is the initial vertex, then the topological configuration of the polygon-fans around the vertex 7 is configuration C3; when the vertex 12 is the initial vertex, then the topological configuration of the polygon-fans around vertex 12 is configuration C7. To take advantage, a separate context is used to code the topological configurations of the polygon-fans around the pivot vertex that is the initial vertex of a connected component.

In some aspects, improved context coding can be used when the pivot vertex is not the initial vertex of a connected component.

When the pivot vertex is not the initial vertex of a connected component, the existence of an unvisited polygon-fan around the pivot can be coded by using different contexts, depending on the situation around the pivot. In an example, the total angle of visited corners around the pivot vertex is used to determine the context. An approximation of the total angle, such as diamond angle (refers to quantized angles using integer values of 0-63 to represent 0-359°), can also be used to determine the context. The rational is that, when the (approximated) total angle of visited corners is large, then it's more likely to have fewer unvisited polygon-fans around the pivot. For example, the index of the context for coding the existence of an unvisited polygon-fan around the pivot can be calculated by Eq. (1):

$$contexIndex = clamp ( \frac{( totalAngle - m )}{d} , 0 , n ) \qquad Eq . ( 1 )$$

where “totalAngle” is the total diamond angle that is an integer, and d, m, n are pre-determined integer constants, and the division over d is integer division.

In another example, the context for coding the existence of an unvisited polygon-fan around the pivot can also be determined by the pivot's neighborhood information, the neighborhood information includes the left and the right vertices relative to the pivot vertex.

In some examples, the total angle of visited corners about the pivot vertex and the neighborhood information of the pivot vertex are combined to determine the context for coding the existence of an unvisited polygon-fan around the pivot vertex.

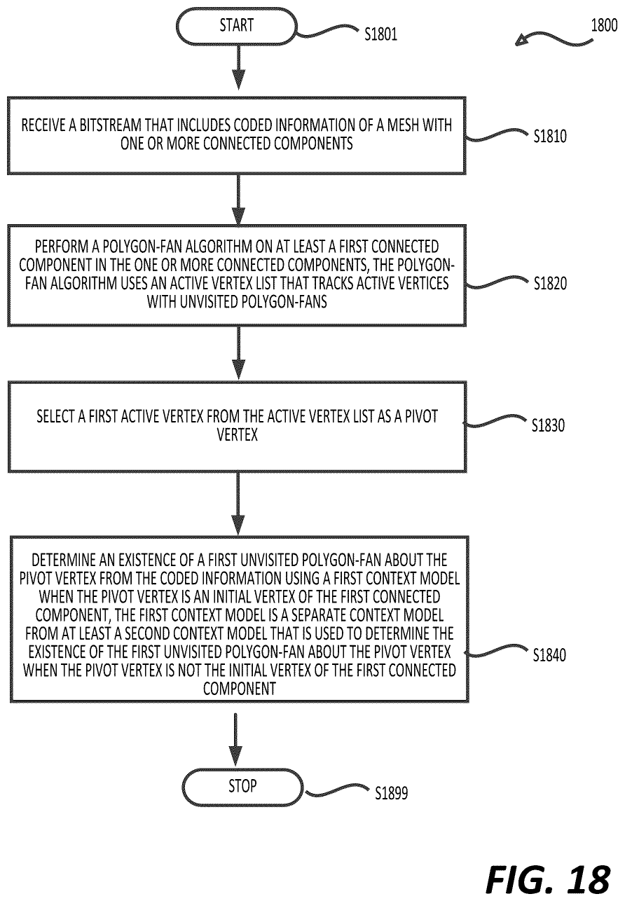

FIG. 18 shows a flow chart outlining a process (1800) according to an aspect of the disclosure. The process (1800) can be used in a mesh decoder. In various aspects, the process (1800) is executed by processing circuitry, such as the processing circuitry that performs functions of the 3D decoder (110), and the like. In some aspects, the process (1800) is implemented in software instructions, thus when the processing circuitry executes the software instructions, the processing circuitry performs the process (1800). The process starts at (S1801) and proceeds to (S1810).

At (S1810), a bitstream is received, the bitstream includes coded information of a mesh with one or more connected components.

At (S1820), a polygon-fan algorithm is applied on at least a first connected component in the one or more connected components, the polygon-fan algorithm uses an active vertex list that tracks active vertices with unvisited polygon-fans.

At (S1830), a first active vertex is selected from the active vertex list as a pivot vertex.

At (S1840), an existence of a first unvisited polygon-fan about the pivot vertex is determined from the coded information using a first context model when the pivot vertex is an initial vertex of the first connected component, the first context model is a separate context model from at least a second context model that is used to determine the existence of the first unvisited polygon-fan about the pivot vertex when the pivot vertex is not the initial vertex of the first connected component.

In some examples, an existence of at least a second unvisited polygon-fan about the pivot vertex is determined from the coded information using a third context model when the pivot vertex is the initial vertex of the first connected component, the third context model is a separate context model from at least a fourth context model that is used to determine the existence of at least the second unvisited polygon-fan about the pivot vertex when the pivot vertex is not the initial vertex of the first connected component.

In some examples, a topological configuration of an unvisited polygon-fan about the pivot vertex is determined from the coded information based on a first configuration context model when the pivot vertex is the initial vertex of the first connected component, the first configuration context model is a separate context model from at least a second configuration context model that is used to determine the topological configuration of the unvisited polygon-fan when the pivot vertex is not the initial vertex of the first connected component.

In some examples, a total angle of visited corners of the pivot vertex is determined (e.g., calculated) when the pivot vertex is not the initial vertex of the first connected component. A context model for coding the existence of the first unvisited polygon-fan about the pivot vertex is determined according to the total angle.

In some examples, neighborhood information of the pivot vertex is determined when the pivot vertex is not the initial vertex of the first connected component. A context model for coding the existence of the first unvisited polygon-fan about the pivot vertex is determined according to the neighborhood information.

In some examples, a total angle of visited corners of the pivot vertex and neighborhood information of the pivot vertex are determined when the pivot vertex is not the initial vertex of the first connected component. A context model for coding the existence of the first unvisited polygon-fan about the pivot vertex is determined according to a combination of the total angle and the neighborhood information.

Then, the process proceeds to (S1899) and terminates.

The process (1800) can be suitably adapted. Step(s) in the process (1800) can be modified and/or omitted. Additional step(s) can be added. Any suitable order of implementation can be used.

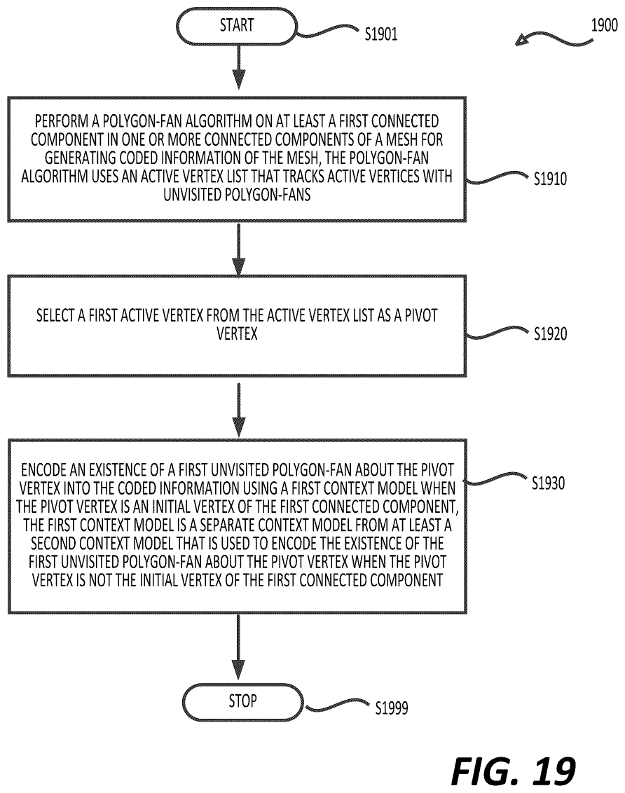

FIG. 19 shows a flow chart outlining a process (1900) according to an aspect of the disclosure. The process (1900) can be used in a mesh encoder. In various aspects, the process (1900) is executed by processing circuitry, such as the processing circuitry that performs functions of the 3D encoder (103), and the like. In some aspects, the process (1900) is implemented in software instructions, thus when the processing circuitry executes the software instructions, the processing circuitry performs the process (1900). The process starts at (S1901) and proceeds to (S1910).

At (S1910), a polygon-fan algorithm is performed on at least a first connected component in one or more connected components of a mesh for generating coded information of the mesh, the polygon-fan algorithm uses an active vertex list that tracks active vertices with unvisited polygon-fans.

At (S1920), a first active vertex is selected from the active vertex list as a pivot vertex.

At (S1930), an existence of a first unvisited polygon-fan about the pivot vertex is encoded into the coded information using a first context model when the pivot vertex is an initial vertex of the first connected component, the first context model is a separate context model from at least a second context model that is used to encode the existence of the first unvisited polygon-fan about the pivot vertex when the pivot vertex is not the initial vertex of the first connected component.

In some examples, an existence of at least a second unvisited polygon-fan about the pivot vertex is encoded into the coded information using a third context model when the pivot vertex is the initial vertex of the first connected component, the third context model is a separate context model from at least a fourth context model that is used to encode the existence of at least the second unvisited polygon-fan about the pivot vertex when the pivot vertex is not the initial vertex of the first connected component.

In some examples, a topological configuration of an unvisited polygon-fan about the pivot vertex is encoded into the coded information using a first configuration context model when the pivot vertex is the initial vertex of the first connected component, the first configuration context model is a separate context model from at least a second configuration context model that is used to encode the topological configuration of the unvisited polygon-fan when the pivot vertex is not the initial vertex of the first connected component.

In some examples, a total angle of visited corners of the pivot vertex is determined when the pivot vertex is not the initial vertex of the first connected component. A context model for encoding the existence of the first unvisited polygon-fan about the pivot vertex is determined according to the total angle.

In some examples, neighborhood information of the pivot vertex is determined when the pivot vertex is not the initial vertex of the first connected component. A context model for encoding the existence of the first unvisited polygon-fan about the pivot vertex is determined according to the neighborhood information.

In some examples, a total angle of visited corners of the pivot vertex and neighborhood information of the pivot vertex are determined when the pivot vertex is not the initial vertex of the first connected component. A context model for encoding the existence of the first unvisited polygon-fan about the pivot vertex is determined according to a combination of the total angle and the neighborhood information.

Then, the process proceeds to (S1999) and terminates.

The process (1900) can be suitably adapted. Step(s) in the process (1900) can be modified and/or omitted. Additional step(s) can be added. Any suitable order of implementation can be used.

According to an aspect of the disclosure, a method of processing mesh is provided. In the method, a conversion between a mesh file and a bitstream of compressed mesh is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a polygon mesh includes vertices that are connected into polygons, the coded information of the polygon mesh indicates coded information of a mesh with one or more connected components. The format rule specifies that: a polygon-fan algorithm is applied on at least a first connected component in the one or more connected components, the polygon-fan algorithm uses an active vertex list that tracks active vertices with unvisited polygon-fans. A first active vertex is selected from the active vertex list as a pivot vertex. An existence of a first unvisited polygon-fan about the pivot vertex is determined from the coded information using a first context model when the pivot vertex is an initial vertex of the first connected component, the first context model is a separate context model from at least a second context model that is used to determine the existence of the first unvisited polygon-fan about the pivot vertex when the pivot vertex is not the initial vertex of the first connected component.

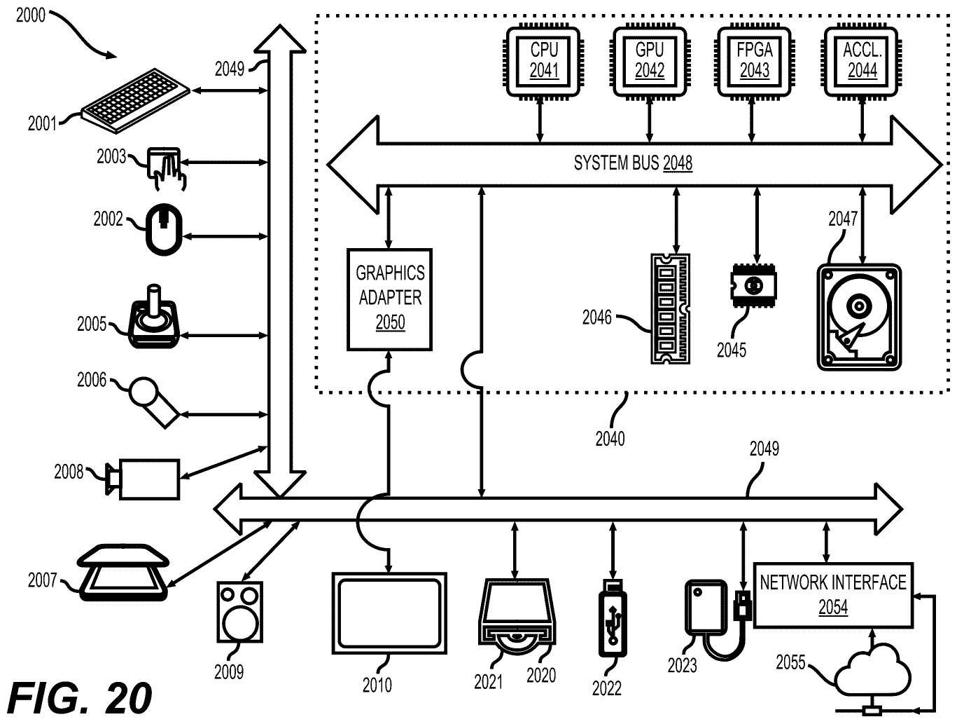

The techniques described above, can be implemented as computer software using computer-readable instructions and physically stored in one or more computer-readable media. For example, FIG. 20 shows a computer system (2000) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 20 for computer system (2000) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (2000).

Computer system (2000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2001), mouse (2002), trackpad (2003), touch screen (2010), data-glove (not shown), joystick (2005), microphone (2006), scanner (2007), camera (2008).

Computer system (2000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2010), data-glove (not shown), or joystick (2005), but there can also be tactile feedback devices that do not serve as input devices), audio output devices (such as: speakers (2009), headphones (not depicted)), visual output devices (such as screens (2010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2000) can also include human accessible storage devices and their associated media such as optical media including CD/DVD ROM/RW (2020) with CD/DVD or the like media (2021), thumb-drive (2022), removable hard drive or solid state drive (2023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2000) can also include an interface (2054) to one or more communication networks (2055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2049) (such as, for example USB ports of the computer system (2000)); others are commonly integrated into the core of the computer system (2000) by attachment to a system bus as described below (for example Ethernet interface into a PC computer system or cellular network interface into a smartphone computer system). Using any of these networks, computer system (2000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2040) of the computer system (2000).

The core (2040) can include one or more Central Processing Units (CPU) (2041), Graphics Processing Units (GPU) (2042), specialized programmable processing units in the form of Field Programmable Gate Areas (FPGA) (2043), hardware accelerators for certain tasks (2044), graphics adapters (2050), and so forth. These devices, along with Read-only memory (ROM) (2045), Random-access memory (2046), internal mass storage such as internal non-user accessible hard drives, SSDs, and the like (2047), may be connected through a system bus (2048). In some computer systems, the system bus (2048) can be accessible in the form of one or more physical plugs to enable extensions by additional CPUs, GPU, and the like. The peripheral devices can be attached either directly to the core's system bus (2048), or through a peripheral bus (2049). In an example, the screen (2010) can be connected to the graphics adapter (2050). Architectures for a peripheral bus include PCI, USB, and the like.

CPUs (2041), GPUs (2042), FPGAs (2043), and accelerators (2044) can execute certain instructions that, in combination, can make up the aforementioned computer code. That computer code can be stored in ROM (2045) or RAM (2046). Transitional data can also be stored in RAM (2046), whereas permanent data can be stored for example, in the internal mass storage (2047). Fast storage and retrieve to any of the memory devices can be enabled through the use of cache memory, that can be closely associated with one or more CPU (2041), GPU (2042), mass storage (2047), ROM (2045), RAM (2046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2000), and specifically the core (2040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2040) that are of non-transitory nature, such as core-internal mass storage (2047) or ROM (2045). The software implementing various aspects of the present disclosure can be stored in such devices and executed by core (2040). A computer-readable medium can include one or more memory devices or chips, according to particular needs. The software can cause the core (2040) and specifically the processors therein (including CPU, GPU, FPGA, and the like) to execute particular processes or particular parts of particular processes described herein, including defining data structures stored in RAM (2046) and modifying such data structures according to the processes defined by the software. In addition or as an alternative, the computer system can provide functionality as a result of logic hardwired or otherwise embodied in a circuit (for example: accelerator (2044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of mesh processing, including: receiving a bitstream including coded information of a polygon mesh, the polygon mesh including vertices that are connected into polygons, the coded information indicating connectivity information of the vertices; determining a first connectivity of a first polygon-fan with a first vertex being a pivot vertex of the first polygon-fan according to the coded information; detecting that a second vertex in the first polygon-fan is a visited vertex that has existing neighborhood information; checking whether the existing neighborhood information of the second vertex and new neighboring information of the second vertex in the first polygon-fan satisfy a condition; and updating the existing neighborhood information of the second vertex based on the new neighboring information when the condition is satisfied.

(2). The method of feature (1), in which the checking further includes: checking whether a left vertex is set in the existing neighborhood information of the second vertex; and when the left vertex is set in the existing neighborhood information of the second vertex, checking whether the left vertex in the existing neighborhood information is equal to a right vertex of the second vertex in the first polygon-fan.

(3). The method of any of features (1) to (2), in which the updating includes: when the left vertex in the existing neighborhood information is not equal to the right vertex of the second vertex in the first polygon-fan, updating a right vertex in the existing neighborhood information according to the right vertex of the second vertex in the first polygon-fan.

(4). The method of any of features (1) to (3), further including: updating a right pivot in the existing neighborhood information according to the pivot vertex of the first polygon-fan.

(5). The method of any of features (1) to (4), in which the checking further includes: checking whether a right vertex is set in the existing neighborhood information of the second vertex; and when the right vertex is set in the existing neighborhood information of the second vertex, checking whether the right vertex in the existing neighborhood information is equal to a left vertex of the second vertex in the first polygon-fan.

(6). The method of any of features (1) to (5), in which the updating includes: when the right vertex in the existing neighborhood information is not equal to the left vertex of the second vertex in the first polygon-fan, updating a left vertex in the existing neighborhood information according to the left vertex of the second vertex in the first polygon-fan.

(7). The method of any of features (1) to (6), further including: updating a left pivot in the existing neighborhood information according to the pivot vertex of the first polygon-fan.

(8). The method of any of features (1) to (7), further including: resetting a left vertex and/or a right vertex in the existing neighborhood information of the second vertex to an unvisited state when the existing neighborhood information and the new neighboring information satisfy one or more conditions.

(9). The method of any of features (1) to (8), further including: resetting the left vertex in the existing neighborhood information of the second vertex when the left vertex in the existing neighborhood information matches a right vertex of the second vertex in the first polygon-fan; and/or resetting the right vertex in the existing neighborhood information of the second vertex when the right vertex in the existing neighborhood information matches a left vertex of the second vertex in the first polygon-fan.

(10). The method of any of features (1) to (9), further including: when the second vertex becomes a pivot vertex, deriving a connectivity of a second polygon-fan that is incident to the second vertex based on the existing neighborhood information of the second vertex.

(11). A method of mesh processing, including: encoding a first connectivity of a first polygon-fan into coded information of a polygon mesh, the polygon mesh including vertices that are connected into polygons, the first polygon-fan including a first vertex being a pivot vertex of the first polygon-fan; detecting that a second vertex in the first polygon-fan is a visited vertex that has existing neighborhood information; checking whether the existing neighborhood information of the second vertex and new neighboring information of the second vertex in the first polygon-fan satisfy a condition; and updating the existing neighborhood information of the second vertex based on the new neighboring information when the condition is satisfied.

(12). The method of feature (11), in which the checking further includes: checking whether a left vertex is set in the existing neighborhood information of the second vertex; and when the left vertex is set in the existing neighborhood information of the second vertex, checking whether the left vertex in the existing neighborhood information is equal to a right vertex of the second vertex in the first polygon-fan.

(13). The method of any of features (11) to (12), in which the updating includes: when the left vertex in the existing neighborhood information is not equal to the right vertex of the second vertex in the first polygon-fan, updating a right vertex in the existing neighborhood information according to the right vertex of the second vertex in the first polygon-fan.

(14). The method of any of features (11) to (13), further including: updating a right pivot in the existing neighborhood information according to the pivot vertex of the first polygon-fan.

(15). The method of any of features (11) to (14), in which the checking further includes: checking whether a right vertex is set in the existing neighborhood information of the second vertex; and when the right vertex is set in the existing neighborhood information of the second vertex, checking whether the right vertex in the existing neighborhood information is equal to a left vertex of the second vertex in the first polygon-fan.

(16). The method of any of features (11) to (15), in which the updating includes: when the right vertex in the existing neighborhood information is not equal to the left vertex of the second vertex in the first polygon-fan, updating a left vertex in the existing neighborhood information according to the left vertex of the second vertex in the first polygon-fan.

(17). The method of any of features (11) to (16), further including: updating a left pivot in the existing neighborhood information according to the pivot vertex of the first polygon-fan.

(18). The method of any of features (11) to (17), further including: resetting a left vertex and/or a right vertex in the existing neighborhood information of the second vertex to an unvisited state when the existing neighborhood information and the new neighboring information satisfy one or more conditions.

(19). The method of any of features (11) to (18), further including: when the second vertex becomes a pivot vertex, encoding a connectivity of a second polygon-fan that is incident to the second vertex based on the existing neighborhood information of the second vertex.

(20). A method of processing mesh data, the method including: processing a bitstream of coded information of a polygon mesh according to a format rule, in which: the polygon mesh includes vertices that are connected into polygons, the coded information indicates connectivity information of the vertices the polygon mesh; and the format rule specifies that: a first connectivity of a first polygon-fan with a first vertex being a pivot vertex of the first polygon-fan is determined according to the coded information; a second vertex in the first polygon-fan being a visited vertex that has existing neighborhood information is detected; whether the existing neighborhood information of the second vertex and new neighboring information of the second vertex in the first polygon-fan satisfy a condition is checked; and the existing neighborhood information of the second vertex is updated based on the new neighboring information when the condition is satisfied.

(21). A method of mesh decoding, including: receiving a bitstream that includes coded information of a mesh with one or more connected components; determining, from the coded information of the mesh, that the mesh is coded based on a closed 2-manifold mesh; and constructing, using a polygon-fan algorithm, the closed 2-manifold mesh based on the coded information, the polygon-fan algorithm using a single topological configuration for coding polygon-fans in the closed 2-manifold mesh.

(22). The method of feature (21), the method including: decoding, from the coded information of the mesh, dummy face information that indicates one or more dummy faces that are added into the mesh; and generating, a restored mesh from the closed 2-manifold mesh with the one or more dummy faces being removed from the closed 2-manifold mesh.

(23). The method of any of features (21) to (22), in which the single topological configuration has no split vertices.

(24). The method of any of features (21) to (23), in which the constructing includes: decoding, from the coded information, a face degree of an initial face of a first connected component in the one or more connected components; decoding positions of vertices of the initial face from the coded information; adding the vertices of the initial face into an active vertex list; selecting a vertex in the active vertex list as a pivot vertex; decoding, from the coded information, a number of one or more polygon-fans about the pivot vertex, the one or more polygon-fans having the single topological configuration; decoding positions of new vertices of the one or more polygon-fans from the coded information; and adding the new vertices in the active vertex list.

(25). The method of any of features (21) to (24), further including: decoding split vertex information of the one or more polygon-fans.

(26). The method of any of features (21) to (25), in which the one or more polygon-fans are triangle-fans.

(27). A method of mesh encoding, including: converting a mesh into a closed 2-manifold mesh by adding one or more dummy faces in the mesh; generating coded information of the closed 2-manifold mesh using a polygon-fan algorithm, the polygon-fan algorithm using a single topological configuration; and generating a bitstream that includes coded information of the mesh, the coded information of the mesh including the coded information of the closed 2-manifold mesh and dummy face information, the dummy face information indicating the one or more dummy faces.

(28). The method of feature (27), in which the single topological configuration has no split vertices.

(29). The method of any of features (27) to (28), in which the generating the coded information includes: encoding, into the coded information, a face degree of an initial face of a first connected component in the closed 2-manifold mesh; encoding positions of vertices of the initial face into the coded information; adding the vertices of the initial face into an active vertex list; selecting a vertex in the active vertex list as a pivot vertex; encoding, into the coded information, a number of one or more polygon-fans about the pivot vertex, the one or more polygon-fans having the single topological configuration; encoding positions of new vertices of the one or more polygon-fans into the coded information; and adding the new vertices in the active vertex list.

(30). The method of any of features (27) to (29), further including: encoding split vertex information of the one or more polygon-fans into the coded information.

(31). The method of any of features (27) to (30), in which the one or more polygon-fans are triangle-fans.

(32). A method of processing mesh data, the method including: processing a bitstream of coded information of a polygon mesh according to a format rule, in which: the coded information of the polygon mesh indicates coded information of a mesh with one or more connected components. The format rule specifies that: the polygon mesh is coded based on a closed 2-manifold mesh with one or more dummy faces added; by using a polygon-fan algorithm, the closed 2-manifold mesh is reconstructed based on the coded information; and the polygon-fan algorithm uses a single topological configuration for coding polygon-fans in the closed 2-manifold mesh.

(33). A method of mesh decoding, including: receiving a bitstream that includes coded information of a mesh with one or more connected components; performing a polygon-fan algorithm on at least a first connected component in the one or more connected components, the polygon-fan algorithm using an active vertex list that tracks active vertices with unvisited polygon-fans; selecting a first active vertex from the active vertex list as a pivot vertex; and determining an existence of a first unvisited polygon-fan about the pivot vertex from the coded information using a first context model when the pivot vertex is an initial vertex of the first connected component, the first context model being a separate context model from at least a second context model that is used to determine the existence of the first unvisited polygon-fan about the pivot vertex when the pivot vertex is not the initial vertex of the first connected component.

(34). The method of feature (33), further including: determining an existence of at least a second unvisited polygon-fan about the pivot vertex from the coded information using a third context model when the pivot vertex is the initial vertex of the first connected component, the third context model being a separate context model from at least a fourth context model that is used to determine the existence of at least the second unvisited polygon-fan about the pivot vertex when the pivot vertex is not the initial vertex of the first connected component.

(35). The method of any of features (33) to (34), further including: determining a topological configuration of an unvisited polygon-fan about the pivot vertex from the coded information using a first configuration context model when the pivot vertex is the initial vertex of the first connected component, the first configuration context model being a separate context model from at least a second configuration context model that is used to determine the topological configuration of the unvisited polygon-fan when the pivot vertex is not the initial vertex of the first connected component.

(36). The method of any of features (33) to (35), further including: determining a total angle of visited corners of the pivot vertex when the pivot vertex is not the initial vertex of the first connected component; and determining a context model for coding the existence of the first unvisited polygon-fan about the pivot vertex according to the total angle.

(37). The method of any of features (33) to (36), further including: determining neighborhood information of the pivot vertex when the pivot vertex is not the initial vertex of the first connected component; and determining a context model for coding the existence of the first unvisited polygon-fan about the pivot vertex according to the neighborhood information.

(38). The method of any of features (33) to (37), further including: determining a total angle of visited corners of the pivot vertex and neighborhood information of the pivot vertex when the pivot vertex is not the initial vertex of the first connected component; and determining a context model for coding the existence of the first unvisited polygon-fan about the pivot vertex according to a combination of the total angle and the neighborhood information.

(39). A method of mesh encoding, the method including: performing a polygon-fan algorithm on at least a first connected component in one or more connected components of a mesh for generating coded information of the mesh, the polygon-fan algorithm using an active vertex list that tracks active vertices with unvisited polygon-fans; selecting a first active vertex from the active vertex list as a pivot vertex; and encoding an existence of a first unvisited polygon-fan about the pivot vertex into the coded information using a first context model when the pivot vertex is an initial vertex of the first connected component, the first context model being a separate context model from at least a second context model that is used to encode the existence of the first unvisited polygon-fan about the pivot vertex when the pivot vertex is not the initial vertex of the first connected component.

(40). The method of feature (39), further including: encoding an existence of at least a second unvisited polygon-fan about the pivot vertex into the coded information using a third context model when the pivot vertex is the initial vertex of the first connected component, the third context model being a separate context model from at least a fourth context model that is used to encode the existence of at least the second unvisited polygon-fan about the pivot vertex when the pivot vertex is not the initial vertex of the first connected component.

(41). The method of any of features (39) to (40), further including: encoding a topological configuration of an unvisited polygon-fan about the pivot vertex into the coded information using a first configuration context model when the pivot vertex is the initial vertex of the first connected component, the first configuration context model being a separate context model from at least a second configuration context model that is used to encode the topological configuration of the unvisited polygon-fan when the pivot vertex is not the initial vertex of the first connected component.

(42). The method of any of features (39) to (41), further including: determining a total angle of visited corners of the pivot vertex when the pivot vertex is not the initial vertex of the first connected component; and determining a context model for encoding the existence of the first unvisited polygon-fan about the pivot vertex according to the total angle.

(43). The method of any of features (39) to (42), further including: determining neighborhood information of the pivot vertex when the pivot vertex is not the initial vertex of the first connected component; and determining a context model for encoding the existence of the first unvisited polygon-fan about the pivot vertex according to the neighborhood information.

(44). The method of any of features (39) to (43), further including: determining a total angle of visited corners of the pivot vertex and neighborhood information of the pivot vertex when the pivot vertex is not the initial vertex of the first connected component; and determining a context model for encoding the existence of the first unvisited polygon-fan about the pivot vertex according to a combination of the total angle and the neighborhood information.

(45). A method of processing mesh data, the method including: processing a bitstream of coded information of a polygon mesh according to a format rule, in which: the coded information of the polygon mesh indicates coded information of a mesh with one or more connected components. The format rule specifies that: a polygon-fan algorithm is applied on at least a first connected component in the one or more connected components, the polygon-fan algorithm uses an active vertex list that tracks active vertices with unvisited polygon-fans; a first active vertex is selected from the active vertex list as a pivot vertex; and an existence of a first unvisited polygon-fan about the pivot vertex is determined from the coded information using a first context model when the pivot vertex is an initial vertex of the first connected component, the first context model being a separate context model from at least a second context model that is used to determine the existence of the first unvisited polygon-fan about the pivot vertex when the pivot vertex is not the initial vertex of the first connected component.

(46). An apparatus for mesh processing, including processing circuitry that is configured to perform the method of any of features (1) to (10).

(47). An apparatus for mesh processing, including processing circuitry that is configured to perform the method of any of features (11) to (19).

(48). An apparatus for mesh processing, including processing circuitry that is configured to perform the method of any of features (21) to (26).

(49). An apparatus for mesh processing, including processing circuitry that is configured to perform the method of any of features (27) to (31).

(50). An apparatus for mesh processing, including processing circuitry that is configured to perform the method of any of features (33) to (38).

(51). An apparatus for mesh processing, including processing circuitry that is configured to perform the method of any of features (39) to (44).

(52). A non-transitory computer-readable storage medium storing instructions which when executed by at least one processor cause the at least one processor to perform the method of any of features (1) to (45).

What is claimed is:

1. A method of mesh processing, comprising:
receiving a bitstream including coded information of a polygon mesh, the polygon mesh comprising vertices that are connected into polygons, the coded information indicating connectivity information of the vertices;
determining a first connectivity of a first polygon-fan with a first vertex being a pivot vertex of the first polygon-fan according to the coded information;
detecting that a second vertex in the first polygon-fan is a visited vertex that has existing neighborhood information;
checking whether the existing neighborhood information of the second vertex and new neighboring information of the second vertex in the first polygon-fan satisfy a condition; and
updating the existing neighborhood information of the second vertex based on the new neighboring information when the condition is satisfied.

2. The method of claim 1, wherein the checking further comprises:
checking whether a left vertex is set in the existing neighborhood information of the second vertex; and
when the left vertex is set in the existing neighborhood information of the second vertex, checking whether the left vertex in the existing neighborhood information is equal to a right vertex of the second vertex in the first polygon-fan.

3. The method of claim 2, wherein the updating comprises:
when the left vertex in the existing neighborhood information is not equal to the right vertex of the second vertex in the first polygon-fan, updating a right vertex in the existing neighborhood information according to the right vertex of the second vertex in the first polygon-fan.

4. The method of claim 3, further comprising:
updating a right pivot in the existing neighborhood information according to the pivot vertex of the first polygon-fan.

5. The method of claim 1, wherein the checking further comprises:
checking whether a right vertex is set in the existing neighborhood information of the second vertex; and
when the right vertex is set in the existing neighborhood information of the second vertex, checking whether the right vertex in the existing neighborhood information is equal to a left vertex of the second vertex in the first polygon-fan.

6. The method of claim 5, wherein the updating comprises:
when the right vertex in the existing neighborhood information is not equal to the left vertex of the second vertex in the first polygon-fan, updating a left vertex in the existing neighborhood information according to the left vertex of the second vertex in the first polygon-fan.

7. The method of claim 6, further comprising:
updating a left pivot in the existing neighborhood information according to the pivot vertex of the first polygon-fan.

8. The method of claim 1, further comprising:
resetting a left vertex and/or a right vertex in the existing neighborhood information of the second vertex to an unvisited state when the existing neighborhood information and the new neighboring information satisfy one or more conditions.

9. The method of claim 8, further comprising:
resetting the left vertex in the existing neighborhood information of the second vertex when the left vertex in the existing neighborhood information matches a right vertex of the second vertex in the first polygon-fan; and/or
resetting the right vertex in the existing neighborhood information of the second vertex when the right vertex in the existing neighborhood information matches a left vertex of the second vertex in the first polygon-fan.

10. The method of claim 1, further comprising:
when the second vertex becomes a pivot vertex, deriving a connectivity of a second polygon-fan that is incident to the second vertex based on the existing neighborhood information of the second vertex.

11. A method of mesh processing, comprising:
encoding a first connectivity of a first polygon-fan into coded information of a polygon mesh, the polygon mesh comprising vertices that are connected into polygons, the first polygon-fan including a first vertex being a pivot vertex of the first polygon-fan;
detecting that a second vertex in the first polygon-fan is a visited vertex that has existing neighborhood information;
checking whether the existing neighborhood information of the second vertex and new neighboring information of the second vertex in the first polygon-fan satisfy a condition; and
updating the existing neighborhood information of the second vertex based on the new neighboring information when the condition is satisfied.

12. The method of claim 11, wherein the checking further comprises:
checking whether a left vertex is set in the existing neighborhood information of the second vertex; and
when the left vertex is set in the existing neighborhood information of the second vertex, checking whether the left vertex in the existing neighborhood information is equal to a right vertex of the second vertex in the first polygon-fan.

13. The method of claim 12, wherein the updating comprises:
when the left vertex in the existing neighborhood information is not equal to the right vertex of the second vertex in the first polygon-fan, updating a right vertex in the existing neighborhood information according to the right vertex of the second vertex in the first polygon-fan.

14. The method of claim 13, further comprising:
updating a right pivot in the existing neighborhood information according to the pivot vertex of the first polygon-fan.

15. The method of claim 11, wherein the checking further comprises:
checking whether a right vertex is set in the existing neighborhood information of the second vertex; and
when the right vertex is set in the existing neighborhood information of the second vertex, checking whether the right vertex in the existing neighborhood information is equal to a left vertex of the second vertex in the first polygon-fan.

16. The method of claim 15, wherein the updating comprises:
when the right vertex in the existing neighborhood information is not equal to the left vertex of the second vertex in the first polygon-fan, updating a left vertex in the existing neighborhood information according to the left vertex of the second vertex in the first polygon-fan.

17. The method of claim 16, further comprising:
updating a left pivot in the existing neighborhood information according to the pivot vertex of the first polygon-fan.

18. The method of claim 11, further comprising:
resetting a left vertex and/or a right vertex in the existing neighborhood information of the second vertex to an unvisited state when the existing neighborhood information and the new neighboring information satisfy one or more conditions.

19. The method of claim 11, further comprising:
when the second vertex becomes a pivot vertex, encoding a connectivity of a second polygon-fan that is incident to the second vertex based on the existing neighborhood information of the second vertex.

20. A method of processing mesh data, the method comprising:
processing a bitstream of coded information of a polygon mesh according to a format rule, wherein:
the polygon mesh includes vertices that are connected into polygons, the coded information indicates connectivity information of the vertices the polygon mesh; and
the format rule specifies that:
a first connectivity of a first polygon-fan with a first vertex being a pivot vertex of the first polygon-fan is determined according to the coded information;
a second vertex in the first polygon-fan being a visited vertex that has existing neighborhood information is detected;
whether the existing neighborhood information of the second vertex and new neighboring information of the second vertex in the first polygon-fan satisfy a condition is checked; and
the existing neighborhood information of the second vertex is updated based on the new neighboring information when the condition is satisfied.
